(19) United States
(12) Patent Application Publication
(10) Pub. No.: US 2026/0288823 A1
(43) Pub. Date: Sep. 24, 2026

(54) SYSTEM

(71) Applicant: SoftBank Group Corp., Tokyo (JP)

(72) Inventor: Hitoshi OZAWA, Tokyo (JP)

(73) Assignee: SoftBank Group Corp., Tokyo (JP)

(21) Appl. No.: 19/568,837

(22) Filed: Mar. 17, 2026

(30) Foreign Application Priority Data
Mar. 19, 2025 (JP) 2025-045270

(51) Int. Cl. G06F 16/3329; G06F 40/295; G06F 40/30

(52) U.S. Cl. CPC G06F 16/33295; G06F 40/295; G06F 40/30

(57) ABSTRACT

A system includes a processor that is configured to receive an inquiry from a user via a messaging application and analyze the inquiry using a natural language processing technique, generate, using a generative AI model, a prompt for instructing acquisition of data from sensors and information systems of a city based on a result of the analysis, filter the acquired data using an emotion engine that analyzes an emotional state of the user, and provide information useful for a next action of the user based on a result of the filtering.

### CROSS-REFERENCE TO RELATED APPLICATION

This application is based on and claims priority under 35 USC 119 from Japanese Patent Application No. 2025-045270 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, various messaging applications have become a primary interface through which users request information and services in daily life. At the same time, urban spaces such as smart cities generate a vast amount of heterogeneous data in real time, including sensor outputs, information system logs, and infrastructure status. However, conventional systems that link user inquiries with urban data generally focus on providing factual or statistical information, and do not sufficiently consider emotional states of users or support their next actions in a personalized manner.

Specifically, conventional chatbots and information provision systems have the following problems. First, conventional systems typically respond to user inquiries by directly retrieving predefined information sources, without dynamically constructing prompts or queries tailored to the semantic content of the user's inquiry. As a result, conventional systems cannot effectively leverage generative AI models to orchestrate complex data acquisition from a variety of city sensors and information systems.

Second, conventional systems do not adequately analyze or incorporate the emotional state of the user when filtering or presenting city-related information. For example, even if a user is in a stressed or anxious state, a conventional system may simply provide crowded or noisy options, thereby failing to support the user's psychological well-being or to suggest actions that align with a desired emotional outcome.

Third, in smart city environments, large volumes of real-time data from diverse infrastructure components are available, yet conventional systems often lack a mechanism to generate, based on natural language inquiries, tailored prompts that instruct acquisition, analysis, and selection of such data in a manner that is both context-aware and emotion-aware. Consequently, conventional systems cannot sufficiently assist users in choosing next actions such as selecting a relaxation facility, moving to a quiet park, or otherwise navigating the city in accordance with their current emotional state and needs.

Therefore, there is a need for a system that can: (i) receive user inquiries via a messaging application and perform robust natural language analysis; (ii) use generative AI models to generate prompts that instruct acquisition and processing of city data from sensors and information systems, including smart city infrastructure; and (iii) filter and tailor the obtained data based on an analysis of the user's emotional state, thereby providing information that effectively supports the user's next action.

### SUMMARY

To solve the above problems, the present invention provides a system comprising a processor, wherein the processor is configured to perform a series of coordinated operations that integrate natural language understanding, generative AI-based prompt generation, city data acquisition, and emotion-aware filtering.

According to one aspect of the invention, the processor is configured to receive an inquiry from a user via a messaging application and analyze the inquiry using a natural language processing technique. By performing such analysis, the processor can extract intent, contextual parameters, and semantic nuances from the user's free-form text, thereby enabling generation of precise and contextually appropriate instructions for downstream data acquisition.

According to another aspect of the invention, the processor is configured to generate, using a generative AI model, a prompt for instructing acquisition of data from sensors and information systems of a city based on a result of the natural language analysis. The generative AI model enables dynamic construction of prompts that reflect the user's intent, the domain of interest, and the required granularity of information. In a smart city scenario, the processor is further configured to generate the prompt so as to instruct acquisition of real-time data from infrastructure of a smart city, the data constituting city information of the smart city. As a result, the system can flexibly retrieve up-to-date, heterogeneous information from multiple urban data sources in response to the user's inquiry.

Furthermore, the processor is configured to filter the acquired data using an emotion engine that analyzes an emotional state of the user, and to provide information useful for a next action of the user based on a result of the filtering. The emotion engine may estimate the user's emotional state from textual cues in the inquiry, historical interaction data, or other contextual information. By applying this emotional analysis, the processor can select, emphasize, or suppress portions of the acquired city data in a way that aligns with the user's psychological condition or needs.

In a preferred embodiment, the processor is configured to generate the prompt so as to instruct analysis of the acquired city information and selection and provision, based on the emotional state of the user, of information including at least one of a relaxation facility and a quiet park. For example, when the emotion engine detects stress, anxiety, or fatigue in the user's emotional state, the processor can cause the generative AI model to produce a prompt that emphasizes facilities and locations likely to contribute to relaxation or calmness, and can provide these as prioritized options to the user via the messaging application.

Through these means, the system according to the present invention dynamically ties user inquiries to rich, real-time city data via generative AI-based prompts, and tailors the resulting information based on the user's emotional state. Consequently, the system can effectively support the user's next action in an urban or smart city environment, not only by providing accurate factual information, but also by aligning such information with the user's emotional and behavioral needs.

The term “system” refers to an arrangement of hardware and software components including at least one processor and associated memory, communication interfaces, and executable programs configured to perform the functions recited in the claims. The term “processor” refers to any hardware device or combination of devices capable of executing instructions, including but not limited to a central processing unit (CPU), a graphics processing unit (GPU), a microcontroller, a digital signal processor, or a plurality of such devices operating together.

The term “messaging application” refers to a software application or service that enables a user to transmit and receive messages over a network, including text, voice, and multimedia messages, and that provides a user interface through which the user inputs inquiries to the system.

The term “inquiry” refers to a natural language message or request provided by the user via the messaging application, the message or request expressing a need for information, guidance, or a recommended action.

The term “natural language processing technique” refers to a computational method or algorithm for analyzing and interpreting text or speech expressed in a human language, including but not limited to tokenization, part-of-speech tagging, syntactic parsing, semantic analysis, intent detection, and entity recognition.

The term “generative AI model” refers to a machine learning model that is configured to generate text or other content based on input data, including but not limited to large language models, transformer-based models, and neural network models trained to produce prompts, queries, or instructions.

The term “prompt” refers to data generated by the processor and provided as an instruction or input to another system, service, or model, the instruction specifying at least what type of data is to be acquired, from which source, and under what conditions.

The term “sensor” refers to a device deployed in a city that measures or detects physical, environmental, or situational parameters, such as location, movement, traffic volume, occupancy, sound level, temperature, or other measurable quantities, and that outputs data representing such parameters.

The term “information system of a city” refers to an electronic system or service that stores, processes, or distributes data related to an urban environment, including but not limited to traffic management systems, public transportation systems, facility management systems, and disaster information systems.

The term “city information” refers to data that characterizes conditions or resources in an urban area, including at least traffic status, congestion status of facilities, environmental conditions, availability of public or commercial services, and disaster-related information.

The term “smart city” refers to a city or urban area in which physical infrastructure, public services, and facilities are instrumented with sensors, communication networks, and information systems that enable collection, transmission, and processing of real-time data for management and service optimization.

The term “infrastructure of a smart city” refers to physical and digital components of a smart city, including roads, transportation systems, public utilities, buildings, facilities, sensors, communication networks, and control systems that generate or utilize real-time data.

The term “emotion engine” refers to a software component or set of algorithms executed by the processor that analyze data associated with the user, such as textual content of inquiries, interaction history, or other contextual signals, to estimate or classify an emotional state of the user.

The term “emotional state of the user” refers to a psychological or affective condition of the user, such as stress, relaxation, anxiety, excitement, or calmness, as inferred by the emotion engine from input data.

The term “filtering” refers to a process in which the processor selects, emphasizes, de-emphasizes, or discards portions of acquired data based on one or more criteria, including at least the estimated emotional state of the user, so as to prepare data for presentation to the user.

The term “information useful for a next action of the user” refers to information that is selected and formatted by the processor to assist the user in deciding and performing a subsequent behavior, such as selecting a route, choosing a facility to visit, or moving to a particular location.

The term “relaxation facility” refers to a place or service in an urban area that is intended to promote rest or stress relief for the user, including but not limited to spas, hot springs, wellness centers, massage facilities, and similar venues.

The term “quiet park” refers to a public or semi-public outdoor area designated or identifiable as having relatively low noise levels and low crowding compared to surrounding urban spaces, and that is suitable for rest, relaxation, or calm activities.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

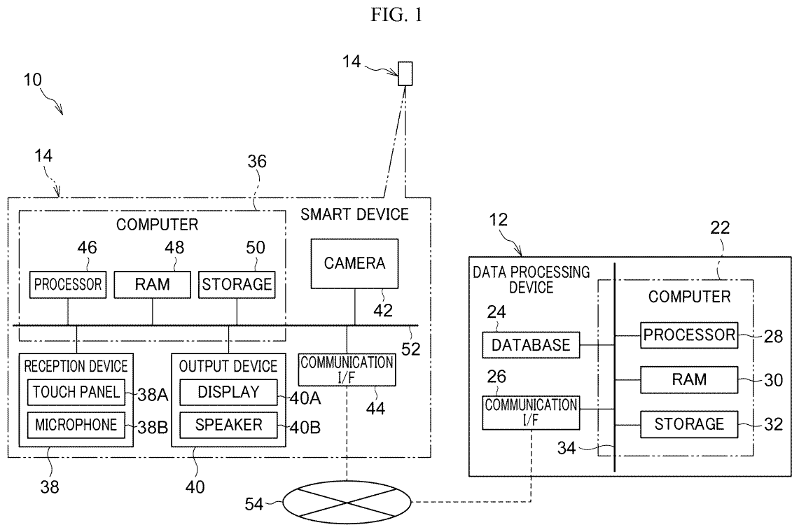

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

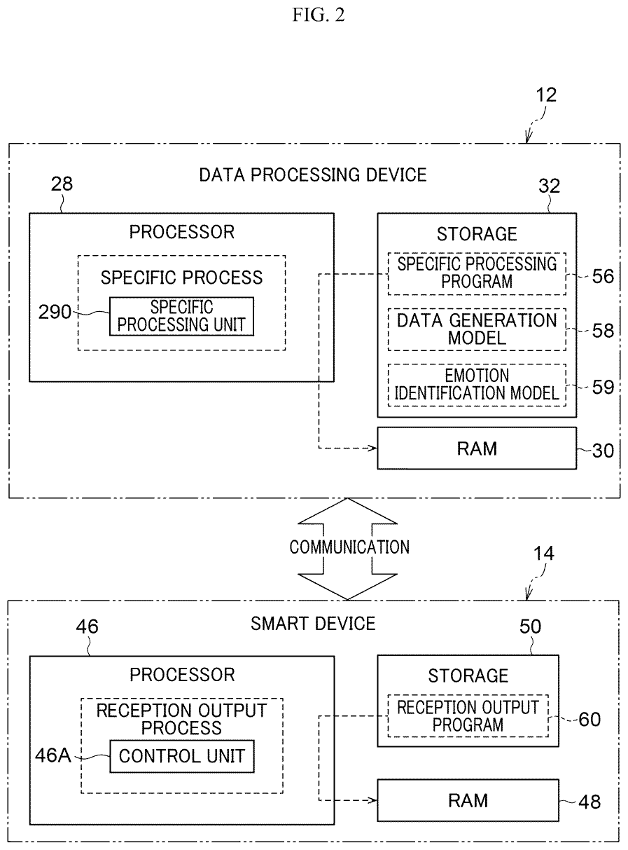

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented urban information systems generally execute a fixed pipeline in which user queries are mapped to predefined application logic, which then retrieves data from limited data sources and returns templated responses. Such systems typically suffer from several technical limitations.

First, known systems often lack an effective mechanism to convert unstructured natural language inquiries into rich, structured representations that can flexibly drive downstream data acquisition and analysis. As a result, backend components cannot optimally select or combine heterogeneous data sources, such as multiple types of sensing devices and information processing devices distributed across an urban infrastructure, leading to incomplete or stale information being returned to the user.

Second, conventional architectures usually treat data retrieval, data analysis, and natural language generation as largely independent modules, connected only through coarse interfaces. In particular, generative models, when used at all, are often invoked with minimal context, without a systematically constructed prompt sentence that integrates structured intent information, real-time sensor data, and computed index values such as congestion degree or crowding degree. This leads to responses that may be fluent but are poorly grounded in current environmental conditions, thereby degrading the reliability and technical usefulness of the system.

Third, many existing systems provide the same response content and style regardless of the psychological state of the user. There is often no technical mechanism to estimate a user's psychological state from the content and context of the user's inquiry, nor to feed this estimation back into the response generation process. Consequently, the system cannot dynamically adapt prompt sentences and generative outputs to better support user decision-making under stress, anxiety, or other states, which results in suboptimal human-computer interaction and reduced efficiency in information comprehension.

Fourth, from a system-level standpoint, these shortcomings manifest as inefficient utilization of computing resources and network bandwidth. Because data sources are not selected based on a precise structured intent, the system may either over-fetch or under-fetch data, and because generative models are not guided by carefully synthesized prompt sentences, the system may generate unnecessarily long or irrelevant outputs, increasing processing time and consumption of computational resources, particularly when using large-scale generative models.

Accordingly, there is a need for an improved computer-implemented technique that (i) transforms natural language inquiries into structured information suitable for automated selection of heterogeneous data sources, (ii) integrates real-time sensor data and information system data into an analysis result used for computing index values, (iii) constructs prompt sentences that tightly couple such analysis results with the original inquiry for input to a generative AI model, and (iv) performs emotion analysis of the user and dynamically adjusts the generation and filtering of response information based on the estimated psychological state. Such a technique should improve the technical functioning of the server system itself, by enabling more accurate data acquisition, better-grounded natural language generation, and adaptive response control that collectively enhance the overall efficiency and reliability of the urban information service.

The specific processing by the specific processing unit 290 of the data processing device 12 in Example 1 is realized by the following means.

The present invention provides a server comprising a processor configured to receive inquiry information from a user terminal via a communication application, convert the inquiry information into structured information including intent information and target area information by using a natural language processing technique, determine, based on the structured information, target data sources and acquisition conditions for obtaining data from a plurality of measurement devices and information providing devices related to an urban environment, generate analysis result data including a result of the determination, integrate time-series data and state data acquired from the target data sources, calculate index values including at least one of congestion degree and crowding degree, generate a prompt sentence including at least the analysis result data and the inquiry information, cause a generative AI model to be executed by using the prompt sentence as input to obtain natural language response information, execute an emotion analysis process for estimating a psychological state of a user based on at least the inquiry information and the integrated data, select or modify the natural language response information in accordance with the psychological state to generate response information useful for a next action of the user, and transmit the response information to the user terminal via the communication application. This enables improvement of the technical functioning of the server system by allowing the processor to dynamically select heterogeneous data sources based on structured intent, to tightly couple computed index values with a generative AI model through a context-rich prompt sentence, and to adapt response generation in real time according to an estimated psychological state of the user, thereby producing technically grounded, resource-efficient, and context-appropriate responses in an urban information environment.

The term “processor” refers to a hardware or virtual processing unit, such as a central processing unit, a graphics processing unit, or a combination of such units, configured to execute instructions of computer programs to perform the functions described in the present disclosure.

The term “user terminal” refers to an information processing apparatus operated by a user, such as a mobile terminal, a portable terminal, or a stationary terminal, that is capable of transmitting inquiry information and receiving response information via a communication network.

The term “communication application” refers to application software or a communication service executed on the user terminal and/or a remote server, which provides a user interface for exchanging messages, including at least text-based messages, between the user terminal and the server.

The term “inquiry information” refers to information representing a request or question from a user, including at least a text message entered by the user via the communication application and optionally associated metadata such as a timestamp, a user identifier, or a location indication.

The term “natural language processing technique” refers to a software-implemented processing technique that analyzes and interprets natural language text, including at least one of tokenization, part-of-speech tagging, syntactic parsing, semantic analysis, named entity recognition, and intent classification.

The term “structured information” refers to data converted from inquiry information into a machine-readable format having defined fields, such as an object or record including at least intent information and target area information, which can be programmatically processed by the processor.

The term “intent information” refers to information indicating a purpose or category of a user's inquiry, such as a request for traffic information, congestion information, disaster information, or facility recommendation, derived from the inquiry information through natural language processing.

The term “target area information” refers to information specifying a geographical region or location relevant to the user's inquiry, including at least one of a place name, a region identifier, or position data, as determined from the inquiry information.

The term “target data source” refers to a hardware or software component from which data related to an urban environment is obtained, including at least one of a measurement device, a detection device, an information processing device, or an external information-providing system.

The term “measurement device” refers to a sensing device or detection device disposed in an environment, such as a sensor installed in infrastructure, that measures physical or operational parameters including at least traffic flow, crowding state, environmental conditions, or facility usage.

The term “information providing device” refers to an information processing apparatus or service that supplies digital information related to an urban environment, including at least operational information of infrastructure, transportation status information, or disaster-related information, via a communication interface.

The term “acquisition condition” refers to a parameter or set of parameters indicating how data is to be obtained from a target data source, including at least one of a location scope, a time range, a data type, or an update interval.

The term “analysis result data” refers to data generated by the processor representing a result of determining target data sources and acquisition conditions, and optionally including summaries or classifications of retrieved data, in a structured and machine-readable format.

The term “time-series data” refers to data consisting of multiple values of a measurement or state associated with respective time points or time intervals, obtained from target data sources over a period of time.

The term “state data” refers to data indicating a current or recent condition or status of an object or system, such as a congestion state, a service operation state, or an alert state, which may or may not be associated with a temporal sequence.

The term “integrated data” refers to data obtained by combining, aligning, or aggregating at least time-series data and state data from a plurality of target data sources into a unified representation for further analysis.

The term “index value” refers to a computed numerical or categorical indicator representing a derived characteristic of the environment, including at least one of congestion degree, crowding degree, delay degree, or risk level, calculated from integrated data or analysis result data.

The term “congestion degree” refers to an index value that expresses the level of traffic congestion or flow restriction in a region, determined based on data such as vehicle speed, volume, occupancy, or similar traffic-related measurements.

The term “crowding degree” refers to an index value that expresses the level of human or object density in a region, determined based on data such as people counts, occupancy rates, or similar crowd-related measurements.

The term “prompt sentence” refers to information including at least natural language text provided as input to a generative AI model, the information comprising one or more of the inquiry information, the analysis result data, the index values, and explicit instructions for response generation.

The term “generative AI model” refers to a trained machine-learned model configured to generate natural language text or other content based on input data, including at least a neural network model that produces natural language response information from a prompt sentence.

The term “natural language response information” refers to text or other natural language content generated by the generative AI model in response to a prompt sentence, representing information intended to be presented to the user.

The term “emotion analysis process” refers to a computational process performed by the processor to estimate a psychological state of a user, including at least an analysis of linguistic features, contextual information, or interaction history to infer states such as stress, anxiety, calmness, or satisfaction.

The term “psychological state” refers to a state related to the user's emotions or mental condition, including at least one of a stress state, an anxiety state, a relaxed state, or another affective state, as estimated by the emotion analysis process.

The term “response information” refers to information generated by the processor for transmission to the user terminal, the information including at least natural language response information that may be selected, modified, or supplemented based on the psychological state and integrated data.

The term “urban environment” refers to an environment including infrastructure and facilities in a populated area, such as roads, transportation systems, public spaces, and buildings, for which measurement devices and information providing devices supply related data.

The term “infrastructure of a city” refers to physical and operational structures and systems deployed in an urban environment, including at least transportation networks, public utilities, public facilities, and related management systems that can be monitored or controlled through data.

In one embodiment, a server cooperates with a terminal operated by a user in order to provide urban information that is dynamically generated based on real-time data, a generative AI model, and emotion analysis. The server includes at least one processor, a memory storing program instructions and data structures, and a network interface. The terminal includes an input/output unit, a display, a network interface, and a local processor capable of executing a communication application.

The server uses the program stored in the memory to implement functional modules including at least a communication module, a natural language processing module, a data source selection module, a data acquisition module, a data integration and index calculation module, an emotion analysis module, a prompt generation module, a generative AI inference module, and a response control module. The server stores intermediate and persistent data in a storage device such as a relational database or a key-value store.

The terminal executes a communication application, which may be implemented as a messaging application, a web-based chat application, or another interactive interface. The terminal provides a text input field and optionally voice input, and the terminal transmits inquiry information as text to the server over a network such as the Internet using a secure protocol such as HTTPS. The terminal receives response information from the server and displays the response information in a message thread or similar user interface.

The server uses the natural language processing module to convert inquiry information into structured information. The server can implement this module by using a general-purpose natural language processing library such as spaCy or NLTK or by invoking a cloud-based natural language processing service. The server stores for each inquiry a structured record in a memory-resident data structure such as a JSON-like object in a key-value store. This structured record includes at least an intent label, a target area identifier, a language indicator, and optional temporal constraints. The server uses tokenization, part-of-speech tagging, named entity recognition, and intent classification to populate these fields.

The server uses the data source selection module to map the structured information to target data sources and acquisition conditions. The server maintains in the memory a data source registry, which is a table or graph structure mapping intent labels and geographic identifiers to available measurement devices and information providing devices. For example, for a “traffic_status” intent and a given station area identifier, the server refers to the registry and selects a set of road traffic sensors, public transportation status APIs, and crowd sensors associated with that identifier. The server generates acquisition conditions including a time range, sampling interval, and specific sensor identifiers based on the urgency and type of the inquiry.

The server uses the data acquisition module to retrieve data from the target data sources. The server connects to measurement devices via an Internet-of-Things platform using a protocol such as MQTT or HTTPS and requests sensor readings such as vehicle counts, average speed, or occupancy percentages. The server connects to information providing devices via an application programming interface and obtains operational data such as train delays, service status, or event alerts. The server buffers the retrieved data in memory and tags each datum with a timestamp, a location identifier, and a source identifier.

The server uses the data integration and index calculation module to integrate time-series data and state data and to compute index values. The server merges sensor readings and status information based on time alignment and location identifiers. The server uses numerical libraries to perform aggregation operations such as computing moving averages of speed over a time window, counting the number of events in a period, or estimating crowd density from multiple sensors. The server then calculates index values including congestion degree and crowding degree according to predefined formulas or learned models. For example, the server can calculate congestion degree as a normalized value derived from average speed and road capacity and can calculate crowding degree as a normalized value derived from people counts and area size.

The server uses the emotion analysis module to estimate a psychological state of the user. The server analyzes textual features of the inquiry information such as sentiment polarity, presence of urgency expressions, and word choice, as well as contextual features such as the history of recent queries and the severity of the underlying index values. The server implements this analysis using either a rule-based classifier or a machine-learned model such as a recurrent neural network or a transformer-based classifier trained on annotated examples of stress, anxiety, or calmness. The server outputs a psychological state label such as “stress,” “anxiety,” or “neutral” and stores this label in association with the inquiry.

The server uses the prompt generation module to construct a prompt sentence for a generative AI model. The server defines in advance one or more template texts stored in the memory. The server selects a template according to the intent label, the target area, and the psychological state. The server then fills variable portions of the template with the original inquiry text, summaries of the analysis result data, and explicit instructions to the generative AI model. In one example, when the user asks about traffic near a particular station, the server generates a prompt sentence such as:

“You are a city information assistant.

The user asked: ‘Tell me the current congestion around Shinjuku Station.’

Here is the analyzed data:
Road A: average speed 12 km/h, congestion: high
Road B: average speed 18 km/h, congestion: medium
Yamanote Line: 10-minute delay, crowding: high
Chuo Line: 15-minute delay, crowding: very high

Explain the current situation in clear English in 3-4 sentences and give one practical suggestion for avoiding delays.”

In another example, when the user asks about disaster-related information near a particular district, the server generates a prompt sentence such as:

“The user asked: ‘Is there any disaster-related information near Shibuya right now?’
Data:
Rainfall: 5 mm/h (low)
River level: normal, no overflow risk
Official warnings: none in the last 2 hours

Answer briefly, reassuringly, and mention what the user should watch for if conditions change.”

The server uses the generative AI inference module to execute a generative AI model on the basis of the prompt sentence. The server may implement this module by invoking a remote generative AI service or by executing a local generative AI model on a hardware accelerator such as a graphics processing unit. The generative AI model can be, for example, a transformer-based neural network including multiple self-attention layers, feed-forward layers, and layer normalization, trained on large-scale language data using an auto-regressive objective. The server provides as input to the model a tokenized representation of the prompt sentence and configures generation parameters such as maximum output tokens, temperature, and sampling strategy. The server executes the forward pass of the neural network to produce probability distributions over tokens at each decoding step and selects output tokens according to the configured sampling strategy to generate natural language response information.

The server uses the response control module to post-process and adapt the natural language response information. The server inspects the generated text to confirm that it includes references to the computed index values, that it satisfies constraints on length and language, and that it does not conflict with critical safety data from the measurement devices. The server can truncate or reformat the text, and, based on the psychological state label, the server can inject or emphasize particular recommendations. For example, when the user is estimated to be in a stress state, the server may instruct the generative AI model through the prompt sentence to include suggestions for quiet areas or relaxation facilities. In such a case, the server may generate a prompt sentence like:

“The user wrote: ‘I feel overwhelmed by the crowds near Tokyo Station this evening. Where should I go instead?’
Crowding data:
Tokyo Station area: very high crowding
Nearby Park X: low crowding
Nearby Shopping Mall Y: medium crowding

Provide a short, empathetic answer in English. Recommend one quieter place and briefly explain why it is suitable.”

The server then transmits the adapted response information to the terminal via the communication module. The terminal receives the response information and updates the display so that the user can view the explanation and recommendations.

The server improves computer technology by introducing specific data structures and processing flows that reduce computational and communication overhead while increasing accuracy of the generated responses. For example, by converting inquiry information into structured information including explicit intent and target area identifiers, the server can restrict data acquisition to only relevant measurement devices and information providing devices, thereby decreasing network traffic and sensor query load, and reducing processing time in the data acquisition and integration modules. The server also computes index values from integrated data before invoking the generative AI model and encodes these index values in the prompt sentence. By doing so, the server constrains the search space of the generative AI model and prevents generation of irrelevant content, which leads to shorter inference time and reduced use of processing resources on the generative AI hardware.

The server implements non-conventional rules and algorithmic steps that differ from human mental steps and from simple automation of manual workflows. The server maintains and updates a data source registry and an acquisition condition policy, and the server applies these machine-readable rules to automatically select subsets of data sources based on structured intent and context. The server also executes an emotion analysis model that uses high-dimensional feature vectors derived from text embeddings, contextual indicators, and real-time index values; these features and the classifier architecture enable fast and consistent psychological state estimation that is not feasible by simple human heuristics at the same scale and speed.

The server trains the generative AI model and the emotion analysis model using machine learning methods prior to deployment. During training of the generative AI model, the server or an external training system stores training data as sequences of tokens and uses an objective function such as cross-entropy loss computed between predicted token distributions and ground-truth tokens. The server or training system updates the model weights by gradient descent or a variant such as Adam, using backpropagation through the transformer layers. During training of the emotion analysis model, the server uses labeled examples of user texts with associated psychological state labels and defines a loss function such as cross-entropy loss over class probabilities. The server updates network weights to minimize this loss, thereby improving classification accuracy.

The server, by structuring the internal data flow into modules and by defining specific intermediate representations, can parallelize parts of the computation. For example, the server can execute data acquisition in parallel with emotion analysis for previously acquired inquiries, and can execute partial preprocessing of sensor data while the generative AI model processes another prompt. This modular and pipelined structure contributes to higher throughput and reduced overall response latency compared to a monolithic, sequential design.

The server can be implemented in multiple variants. In one variant, the server executes all modules on a single machine with multiple processor cores and an attached hardware accelerator. In another variant, the server distributes modules across different computing nodes in a cloud environment, where one node is dedicated to natural language processing and emotion analysis, another node is dedicated to data acquisition from measurement devices and information providing devices, and another node is dedicated to generative AI inference. In yet another variant, the server uses different neural network architectures for the emotion analysis module, such as a convolutional neural network for short texts or a hybrid architecture that combines pre-trained embeddings with a lightweight classifier for edge deployments.

The server can adapt to different types of terminals. The terminal can be a smartphone, a tablet, a wearable device, or an in-vehicle information device. In one embodiment, the terminal provides location information and sensor readings from onboard sensors such as a global navigation satellite system receiver or an accelerometer; the server incorporates these additional signals into the data integration and index calculation module to refine estimates of congestion and crowding around the user.

The server thereby produces technically grounded, context-aware, and psychologically adaptive responses that assist user decision-making in a way that improves the functioning of the computer system itself. By structuring inquiry analysis, data source selection, real-time sensor integration, emotion-aware prompt generation, and generative AI inference as interconnected computational processes, the server reduces unnecessary data transfers, improves the precision of environmental representation, and increases the relevance and reliability of the generated output. This configuration goes beyond simple business logic automation and contributes directly to improved data processing efficiency, faster response times, and reduced error rates in the domain of urban information services.

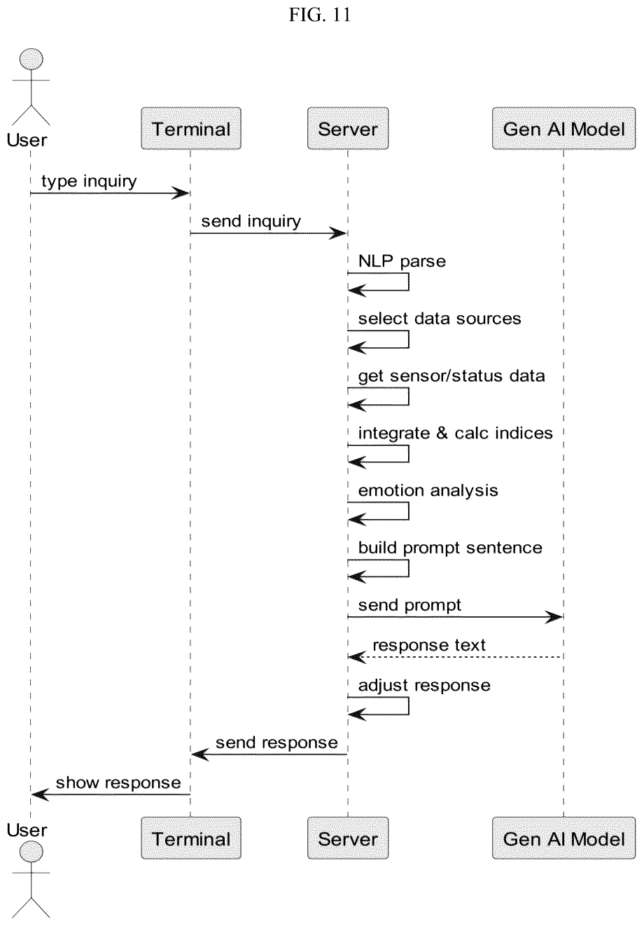

The following describes the processing flow using FIG. 11.

### Step 1:

The user operates the terminal to input inquiry information.

The user opens a communication application on the terminal and types a text message such as “Tell me the current congestion around Shinjuku Station.”

The terminal receives key inputs, constructs a text string, attaches metadata including at least a timestamp and a terminal identifier, and displays the composed message on the screen.

The terminal sets the text string and metadata as input, encapsulates them into a request message, and transmits the request message to the server over a network using a protocol such as HTTPS.

The output of Step 1 is a network request containing the inquiry text and associated metadata.

### Step 2:

The server receives the network request from the terminal.

The server accepts the incoming HTTPS request, terminates the transport layer security session, and parses the request body to extract the inquiry text and the metadata.

The server verifies an authentication token or signature included in the request, and, when the verification succeeds, the server logs the raw inquiry and metadata in a storage device.

The input of Step 2 is the request containing the inquiry text and metadata; the server performs parsing, authentication checking, and logging operations to obtain a clean inquiry text and normalized metadata.

The output of Step 2 is a normalized inquiry object stored in memory, including at least the text field, a user identifier, and a timestamp.

### Step 3:

The server analyzes the inquiry text using a natural language processing technique.

The server passes the text field of the normalized inquiry object to a natural language processing module, which performs tokenization, part-of-speech tagging, and named entity recognition.

The server then applies an intent classification model to the tokenized text to determine an intent label such as “traffic_status,” “disaster_info,” or “facility_recommendation,” and applies an entity resolution process to map extracted place names to internal location identifiers.

The input of Step 3 is the inquiry text and metadata; the server executes linguistic feature extraction and classification algorithms to convert unstructured text into structured fields.

The output of Step 3 is structured information that includes at least the intent label, a target area identifier, a target area name, and optionally temporal constraints and a language code.

### Step 4:

The server determines target data sources and acquisition conditions based on the structured information.

The server accesses a data source registry stored in memory or in a database and retrieves entries that match the intent label and the target area identifier.

The server applies selection rules or a trained decision model to choose a subset of measurement devices and information providing devices, and the server computes acquisition conditions such as time window length, sampling interval, and maximum number of records.

The input of Step 4 is the structured information from Step 3; the server performs table lookup operations and rule evaluation or model inference to map intent and target area to concrete data sources and acquisition parameters.

The output of Step 4 is analysis result data that includes at least a list of identifiers of target data sources and corresponding acquisition conditions.

### Step 5:

The server acquires data from measurement devices according to the acquisition conditions.

The server connects to an IoT platform or sensor gateway using protocols such as MQTT or HTTPS and issues queries or subscription requests that specify sensor identifiers, location identifiers, and time ranges.

The server receives sensor readings including, for example, vehicle counts, average speeds, people counts, or environmental parameters, and the server attaches a unified timestamp and location identifier format to each record.

The input of Step 5 is the list of target measurement device identifiers and acquisition conditions; the server performs network communication, protocol decoding, and basic validation to collect raw sensor data.

The output of Step 5 is a set of time-series sensor records stored in memory, each record including at least a measurement value, a timestamp, a location identifier, and a source identifier.

### Step 6:

The server acquires data from information providing devices according to the acquisition conditions.

The server sends requests to external or internal information systems via application programming interfaces, including parameters such as line identifiers, station identifiers, and requested time.

The server parses responses formatted as structured data, extracts relevant fields such as delay times, service status codes, alert levels, or descriptive messages, and normalizes these fields into a common schema.

The input of Step 6 is the list of target information providing device identifiers and acquisition conditions; the server executes HTTP request operations, response parsing, and field mapping to obtain current status data.

The output of Step 6 is a set of state data records that describe the operational state of infrastructure elements, each record including at least a status value, a timestamp, and a related location or service identifier.

### Step 7:

The server integrates the time-series data and state data and calculates index values.

The server aligns sensor data and status data by joining records on location identifiers and rounding timestamps to predefined time slots, and the server applies aggregation functions such as averaging, counting, or maximum value extraction over a time window.

The server then calculates index values such as congestion degree or crowding degree according to formulas or learned models, for example by normalizing average speed or people count against capacity thresholds and mapping the normalized value to discrete levels (“low,” “medium,” “high”).

The input of Step 7 is the collection of sensor time-series data from Step 5 and state data from Step 6; the server performs time alignment, aggregation, normalization, and mapping operations to derive compact indicators of environmental conditions.

The output of Step 7 is integrated data that includes at least the computed index values, summarized sensor metrics, and summarized status fields for each relevant area or service.

### Step 8:

The server estimates a psychological state of the user by executing an emotion analysis process.

The server constructs a feature vector by combining textual features from the inquiry, such as sentiment scores and keyword counts, with contextual features from the integrated data, such as congestion degree or crowding degree.

The server applies a classifier, such as a trained neural network or another machine learning model, to this feature vector to produce probability values for psychological state categories and then selects the category with the highest probability.

The input of Step 8 is the inquiry text and the integrated data from Step 7; the server executes feature extraction and classification procedures to infer a psychological state label, such as “stress,” “anxiety,” or “neutral.”

The output of Step 8 is the psychological state label and associated confidence values, which the server stores in association with the inquiry.

### Step 9:

The server generates a prompt sentence for a generative AI model.

The server selects a prompt template based on the intent label, target area, and psychological state label, and then fills placeholder fields in the template with the original inquiry text, key parts of the integrated data, and explicit instructions for style and length of the response.

The server concatenates these elements into a single natural language text that conforms to the input format expected by the generative AI model.

The input of Step 9 is the structured information from Step 3, the integrated data and index values from Step 7, and the psychological state from Step 8; the server performs template selection, text insertion, and string concatenation to construct the prompt.

The output of Step 9 is a complete prompt sentence that includes the user question, summarized data, and response guidelines.

### Step 10:

The server executes the generative AI model using the prompt sentence and obtains natural language response information.

The server tokenizes the prompt sentence into a sequence of tokens, passes the tokens through the generative AI model, and configures decoding parameters such as maximum token count and sampling temperature.

The server iteratively decodes output tokens by selecting tokens from the probability distributions produced by the model and then converts the token sequence back into a human-readable text response.

The input of Step 10 is the prompt sentence from Step 9; the server performs tokenization, neural network inference, probabilistic decoding, and detokenization to generate a natural language response.

The output of Step 10 is natural language response information that includes an explanation of current conditions and recommendations related to the user inquiry.

### Step 11:

The server adapts and controls the natural language response information based on the psychological state and system constraints.

The server analyzes the generated text to confirm that it references the computed index values, adheres to a maximum length, and complies with safety rules, and the server may remove or rewrite segments that conflict with critical real-time data.

The server may also modify emphasis or add supplemental phrases in accordance with the psychological state, for example by adding calming wording when the user is in a stress state or by inserting suggestions for quieter locations when crowding degree is high.

The input of Step 11 is the natural language response information from Step 10 and the psychological state label from Step 8; the server performs filtering, truncation, and minor text edits to align the response with technical constraints and user state.

The output of Step 11 is finalized response information that is ready to be sent to the terminal.

### Step 12:

The server transmits the finalized response information to the terminal, and the terminal presents the response to the user.

The server encapsulates the finalized response text into a message format compatible with the communication application and sends it via the network interface using a reply or push mechanism.

The terminal receives the message, decodes the payload, and updates the communication application interface to display the response text below the original inquiry so that the user can read and act upon the information.

The input of Step 12 on the server side is the finalized response information; the server performs message formatting and network transmission, and the terminal performs message reception and rendering on the display.

The output of Step 12 is a visible response on the terminal, conveying to the user the generated explanation and recommendations derived from the generative AI model and the underlying data processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information-provision systems that respond to user inquiries about urban environments generally operate as simple retrieval interfaces to static databases or isolated sensor feeds. Such systems typically lack integrated processing pipelines that can (i) dynamically preprocess heterogeneous time-series and image data from distributed urban devices, (ii) perform predictive analysis of congestion and traffic flow, and (iii) convert the results into context-aware, natural-language responses that directly support a user's visit or movement planning. As a result, existing systems suffer from several technical problems.

First, conventional architectures often treat natural-language understanding, sensor data processing, and response generation as separate, loosely coupled modules. This leads to increased latency, redundant data transfers, and inefficient utilization of computation resources in the server, particularly when real-time urban information must be acquired and aggregated from multiple devices. Second, most systems do not exploit machine-learning-based prediction over preprocessed sensor and image data to estimate congestion levels and traffic-flow indicators as structured numerical values that can be systematically reused across different queries. This limits the precision and adaptability of the responses, and forces each inquiry to trigger ad hoc computation rather than reusing optimized, pipeline-processed data.

Third, traditional chatbots or rule-based dialogue engines are not designed to generate prompt sentences tailored to a generative AI model based on both user intent and structured urban data. As a consequence, the quality of generated text is often inconsistent, and the server cannot effectively guide the generative AI model to produce concise, accurate, and context-specific explanations or recommendations about urban conditions. In addition, known systems typically fail to integrate visual information, such as color-coded congestion maps, with natural-language responses in a unified server-side workflow. This lack of integration increases complexity in client applications and can degrade the overall performance and responsiveness of the system.

Furthermore, conventional systems provide little or no support for dynamically adjusting model prompts and responses in accordance with the real-time properties of incoming urban data and the emotional state of the user. The server therefore cannot optimally select and prioritize information about quiet areas, short-stay areas, or safety-related areas in disaster situations, resulting in suboptimal guidance and unnecessary load on network and computation resources.

Accordingly, there is a need for a technical solution that improves the functioning of the server by tightly integrating natural-language inquiry analysis, real-time preprocessing of heterogeneous urban data, machine-learning-based estimation of congestion and traffic conditions, generation of structured visual information, and controlled use of a generative AI model via tailored prompt sentences. Such a solution should reduce processing latency, increase the relevance and clarity of responses, and provide an efficient mechanism to support user visit and movement planning using a unified, computer-implemented pipeline.

The specific processing by the specific processing unit 290 of the data processing device 12 in Application Example 1 is realized by the following means.

The present invention provides a server comprising a processor configured to receive, via a messaging application executed on a terminal device, an inquiry sentence in natural language from a user and analyze the inquiry sentence, preprocess, based on the analysis of the inquiry sentence, time-series data and image data acquired from detection devices and imaging devices arranged in an urban space by performing noise removal, missing-data compensation, and feature extraction related to movement of people and vehicles, estimate, for the preprocessed data, congestion levels, moving-object densities, and traffic-flow indicators as numerical values by using analysis software including a machine-learning library, generate, on the basis of the estimated results and associated position information and time information, visual information indicating spatial distributions by creating color-coded representations of the congestion levels and traffic conditions, generate, on the basis of the estimated results and the visual information, a prompt sentence to be input to a generative AI model and cause the generative AI model to generate a natural-language response sentence corresponding to the user's inquiry, and transmit, via the messaging application, the generated response sentence and the visual information to the terminal device to provide the transmitted response sentence and visual information in real time as information that supports a visit plan or a movement plan of the user. This enables an integrated and technically improved server-side processing pipeline that efficiently converts heterogeneous, real-time urban data into structured predictions, visual representations, and controlled generative-model outputs, thereby reducing latency, improving the accuracy and relevance of responses, and enhancing the overall functioning of the computer system in providing context-aware urban guidance.

The term “messaging application” refers to a software application executed on a terminal device that enables sending and receiving messages including natural-language text between the user and the server.

The term “terminal device” refers to an information processing device operated by a user, such as a portable communication device, that executes the messaging application and displays responses received from the server.

The term “inquiry sentence” refers to a sequence of natural-language characters or words input by the user via the messaging application to request information or guidance regarding urban conditions.

The term “natural language” refers to a human language, such as a spoken or written language, that is not limited to predefined command formats and is processed by natural-language processing techniques.

The term “urban space” refers to an area including buildings, transportation routes, public facilities, and other infrastructure within a city or similar environment.

The term “detection device” refers to a hardware device installed in the urban space that measures physical quantities, such as presence, movement, or density of people and vehicles, and outputs time-series data.

The term “imaging device” refers to a hardware device, such as a camera or image sensor, installed in the urban space that acquires image data or video data representing scenes of the environment.

The term “time-series data” refers to data values obtained from detection devices at multiple time points, each associated with a timestamp, representing temporal changes in observed quantities.

The term “image data” refers to data representing still images or frames of video acquired by imaging devices, including pixel values or encoded image formats.

The term “general-purpose program execution environment” refers to a software execution environment, such as an operating system with a runtime, that allows execution of application programs for data preprocessing and analysis.

The term “noise removal” refers to a data-processing operation that reduces or eliminates undesired components or outliers from time-series data or image data to improve the reliability of subsequent analysis.

The term “missing-data compensation” refers to a data-processing operation that fills or estimates absent or incomplete data points in time-series data or image data using interpolation, inference, or other techniques.

The term “feature extraction related to movement of people and vehicles” refers to processing that derives numerical or categorical indicators, such as counts, speeds, or densities of people and vehicles, from time-series data and image data.

The term “analysis software including a machine-learning library” refers to a software component executed by the processor that performs data analysis using one or more machine-learning algorithms provided by a reusable software library.

The term “congestion level” refers to a numerical indicator representing a degree of crowding or density of people or vehicles in a specified area and time.

The term “moving-object density” refers to a numerical indicator representing the number or concentration of moving objects, such as people or vehicles, per unit area or per unit length of a route.

The term “traffic-flow indicator” refers to a numerical or categorical value representing a condition of traffic, including speed, throughput, or congestion state on a road or in a transportation network.

The term “position information” refers to data indicating a geographical or spatial location, such as coordinates or area identifiers associated with sensor data and estimation results.

The term “time information” refers to data indicating a point in time or a time interval, such as timestamps or time ranges, associated with acquisition or estimation of data.

The term “visual information indicating spatial distributions” refers to image or graphical data that represents estimated congestion levels, moving-object densities, or traffic conditions over a geographic area.

The term “color-coded representation” refers to a visual representation in which different ranges of congestion levels or traffic conditions are mapped to different colors to facilitate intuitive understanding.

The term “image-processing library” refers to a software library providing functions for generating, modifying, or annotating image data used to create the visual information.

The term “prompt sentence” refers to a text string constructed by the processor and provided as input to a generative AI model to control and guide generation of a natural-language response.

The term “generative AI model” refers to an artificial-intelligence model that generates natural-language text or other content in response to an input prompt sentence, based on learned parameters.

The term “natural-language response sentence” refers to a sequence of natural-language characters or words generated by the generative AI model as a reply to the user's inquiry.

The term “visit plan” refers to a schedule or route for visiting one or more locations in the urban space, planned by the user using information provided by the system.

The term “movement plan” refers to a schedule, route, or strategy for moving between locations in the urban space, including selection of paths or times, planned by the user using information provided by the system.

The term “urban information” refers to data related to conditions in the urban space, including congestion levels, moving-object densities, traffic-flow indicators, and other environment-related attributes.

The term “urban infrastructure” refers to physical and digital facilities that support operation of a city, including transportation networks, communication networks, sensing networks, and public facilities.

The term “real-time property of the urban information” refers to a characteristic that the urban information is acquired, processed, and updated with low delay relative to the actual state of the urban space.

The term “emotional state of the user” refers to an inferred psychological condition of the user, such as stress level or relaxation preference, estimated from user input and system outputs.

The term “emotion-analysis software” refers to a software component that processes text or other signals related to the user to estimate the emotional state of the user using computational methods.

The term “area having high quietness” refers to a spatial region in the urban space characterized by relatively low levels of noise, crowding, or disturbance based on the analyzed data.

The term “area having short dwell time” refers to a spatial region in the urban space where an expected time for a user to stay or wait is relatively short based on the estimated congestion and flow.

The term “evacuation-related area” refers to a spatial region associated with emergency or disaster response, such as a shelter or evacuation route, intended for safe movement or staying of users.

The term “safety” refers to a property of an area indicating a relative degree of risk associated with hazards, congestion, or impediments, as inferred from sensor data, traffic conditions, and other information.

In an embodiment, a server cooperates with one or more terminal devices operated by a user to provide real-time, context-aware urban information using a generative AI model controlled by structured prompt sentences. The server, the terminal, and the user each play distinct roles, and specific hardware and software components are combined to realize the claimed system.

### A. Overall Configuration of Hardware and Software

The server includes at least one processor, a main memory, a non-volatile storage device, a network interface, and an input/output interface. The server is connected via a communication network, such as the Internet or a mobile communication network, to a plurality of terminal devices and a plurality of urban devices including detection devices and imaging devices. The server may be implemented on a general-purpose computing platform, such as a rack-mounted computer with a multi-core central processing unit, a graphics processing unit, a main memory, and a mass storage device.

The terminal includes at least one processor, a display, a user input interface such as a touch panel, a wireless communication module, and a memory. The terminal can be a smartphone or tablet computer that executes a messaging application. The messaging application can be implemented as native application software or as a web application executed in a browser.

The urban devices include detection devices, such as people-count sensors, vehicle-count sensors, and environmental sensors, as well as imaging devices, such as fixed cameras installed at intersections, building entrances, or public squares. Each urban device is connected to the network, either directly or through a gateway, and transmits time-series data or image data to the server.

The server executes multiple software modules. In an embodiment, the server executes an operating system such as a general-purpose operating system, a data processing environment such as a Python runtime, a machine-learning framework such as a deep learning library, an image-processing library, a natural-language processing library, and a generative AI model runtime. The server also executes messaging backend software to communicate with terminals.

### B. Server-Side Data Structures and Preprocessing

The server stores time-series data received from detection devices in a time-indexed data structure, such as a table where each record includes a device identifier, a timestamp, a measured value (for example, number of persons per sampling interval), and auxiliary attributes such as location identifiers and device type. The server stores image data or video frames received from imaging devices in a frame store, such as a collection of records indexed by camera identifier and frame timestamp.

The server uses a data processing module implemented in a general-purpose language runtime, such as a Python environment using numerical computation libraries and data analysis libraries, to preprocess the received data. The server applies noise removal to the time-series data by executing algorithms such as moving average filtering, median filtering, or outlier removal based on statistical thresholds. The server performs missing-data compensation by interpolating missing values using linear interpolation or more sophisticated methods such as spline interpolation, and by discarding or flagging records that cannot be reliably reconstructed.

The server uses an image-processing library such as an open-source computer vision library to perform preprocessing of image data. The server decodes compressed images or video streams into pixel arrays and converts them to a unified color space. The server applies background subtraction or frame differencing to isolate moving objects, and then applies morphological operations to reduce noise. The server uses object-detection networks, for example convolutional neural networks configured as detectors, to identify and classify moving objects in each frame as pedestrians, vehicles, bicycles, or other categories.

The server aggregates preprocessing results into a feature data structure. The feature data structure includes, for each location and time interval, numerical features such as the number of pedestrians, the number of vehicles, average speeds, occupancy ratios, and environmental attributes. The server stores these features in a structured database table that can be efficiently queried by location and time.

### C. Machine-Learning-Based Estimation and Model Architecture

The server uses analysis software including a machine-learning library to estimate congestion levels, moving-object densities, and traffic-flow indicators from the preprocessed feature data. In an embodiment, the server configures a neural network architecture composed of an input layer, one or more temporal processing layers such as recurrent units or one-dimensional convolutional layers, and one or more fully connected output layers.

The server receives, as input to the network, a sequence of feature vectors corresponding to consecutive time intervals for a particular spatial segment. Each feature vector may include a normalized number of pedestrians, a normalized number of vehicles, average speed, historical congestion indicators, and environmental factors. The server normalizes each feature dimension using pre-computed scaling parameters and packs the normalized features into an input tensor with dimensions corresponding to batch size, time steps, and feature dimensions.

The server defines a loss function during training, such as a mean squared error between predicted congestion scores and ground truth scores derived from recorded data. The server performs training on historical data by iteratively computing gradients of the loss with respect to model parameters and updating the weights using an optimization algorithm such as stochastic gradient descent with momentum or an adaptive method. During training, the server applies techniques such as early stopping, dropout, or data augmentation to improve generalization. Once trained, the model parameters are stored in non-volatile memory and loaded for inference.

During inference, the server executes forward propagation through the neural network to obtain, for each spatial segment and future time interval, numerical outputs representing congestion levels, moving-object densities, and traffic-flow indicators. The server converts the raw outputs into standardized ranges; for example, a congestion level may be expressed on a scale of 0 to 100, and a traffic-flow indicator may be discretized into categories such as low, medium, and high based on threshold values. The server stores these estimation results in a prediction table, which may be indexed by location, time, and facility type.

By using this machine-learning-based estimation pipeline, the server improves the technical performance of congestion prediction compared to simpler rule-based methods. The server can handle nonlinear relationships and temporal dependencies in the data, reducing prediction error and enabling more accurate and timely responses to user inquiries.

### D. Generation of Visual Information

The server generates visual information indicating spatial distributions of congestion and traffic by combining the prediction table with geographic data. The server associates each predicted segment with geographic coordinates or polygon regions. The server loads a base map image of the urban area and overlays graphical elements corresponding to the predicted indicators.

The server uses an image-processing library to draw shapes such as rectangles or polygons on the base map, assigning colors to each shape according to the associated congestion level or traffic condition. For example, the server may assign green to low congestion, yellow to medium congestion, and red to high congestion, with intensity representing the exact numerical score. The server may annotate the map with text labels showing numeric values or time ranges.

The server encodes the resulting annotated image into a compressed image format and stores it together with a reference identifier or URL in a visual information table. The terminal can later request the image based on this identifier. This server-side generation of visual information reduces computation load on the terminal and centralizes the logic responsible for visual encoding of traffic conditions.

### E. Natural-Language Analysis and Prompt Sentence Generation

The terminal executes a messaging application and provides an interface for the user to input an inquiry sentence in natural language. The user may type, for example:
“Please tell me the current congestion and the best visiting time for cafes in Shibuya.”
“Show me the traffic situation and any disaster-related information around Tokyo Station right now.”
“Tell me a safe and less crowded route to the nearest evacuation shelter from my current location.”

The terminal transmits the inquiry sentence to the server together with metadata, such as user location and timestamp. The server receives the inquiry and uses a natural-language processing module to analyze the content. The server performs tokenization, part-of-speech tagging, named-entity recognition, and intent detection to extract parameters such as target location, facility type, requested time period, and type of information requested.

The server then queries the feature and prediction tables based on the extracted parameters to obtain structured urban information that corresponds to the inquiry. The server also retrieves relevant visual information identifiers, if available, for maps corresponding to the requested location and time.

The server constructs a prompt sentence to be provided to a generative AI model. The prompt sentence is not simply a copy of the user inquiry, but is modified to include structured data summarizing congestion levels, moving-object densities, traffic-flow indicators, and, if applicable, information about quiet areas or safe routes. The server may include explicit instructions in the prompt sentence to constrain the generative AI model to produce concise, accurate, and context-appropriate responses.

In an embodiment, the server constructs a prompt sentence such as:

“User asked: ‘Please tell me the current congestion and the best visiting time for cafes in Shibuya.’ Current congestion level for cafes in the target area is 82 on a scale of 0 to 100. Peak is expected from 13:00 to 15:00. Recommend a visiting time when congestion is moderate or low, and explain briefly in English.”

By embedding the structured urban data and constraints in the prompt sentence, the server guides the generative AI model to produce responses that are technically precise and aligned with the server's estimation results. This control reduces variability in the model's output and decreases processing overhead, because fewer correction or follow-up queries are typically required.

### F. Generative AI Model Configuration

The server uses a generative AI model implemented as a neural network, for example a transformer-based language model. The model includes a stack of attention layers, feed-forward layers, and embedding layers, with parameters learned from large corpora. The server deploys the model on dedicated computation hardware such as server-grade GPUs to accelerate inference.

The server provides the constructed prompt sentence to the generative AI model and configures inference parameters such as maximum output length, sampling temperature, and decoding strategy (for example, greedy decoding or beam search). The server may apply domain-specific constraints by including control tokens or phrasing instructions in the prompt sentence.

The server receives from the generative AI model a natural-language response sentence, such as:

“Currently, many cafes in Shibuya are crowded, with peak congestion expected between 1 p.m. and 3 p.m. The best time to visit is after 3 p.m., when waiting times are likely to be shorter.”

The server can further process the generated sentence to ensure that it does not contradict the numeric predictions or that it complies with length constraints. The server may also supplement the response with a reference to the visual information identifier for a congestion map of the relevant area.

By structuring the prompt sentence and constraining the model's generation process, the server uses the generative AI model in a non-conventional way that improves computer functionality. The server reduces unnecessary model calls by reusing precomputed predictions, and reduces communication load by generating concise, targeted responses, which leads to lower network traffic and shorter response times.

### G. Emotional State Estimation and Content Selection

In an embodiment, the server estimates an emotional state of the user from the inquiry sentence and optional additional data. The server uses emotion-analysis software that may include a classifier trained on labeled text to output scores for emotional categories such as stress, anxiety, or relaxation preference. The server uses these scores, combined with congestion and traffic indicators, to select information that emphasizes quiet areas, short dwell-time areas, or safe evacuation-related areas.

For example, when the user's inquiry and emotional analysis indicate high stress and a desire for a quiet place, the server selects locations where predicted congestion is below a threshold and where environment-related features indicate lower noise. The server encodes this selection logic in the candidate data set provided to the generative AI model and in the instructions included in the prompt sentence, causing the model to emphasize such areas in the response.

This combination of emotion analysis with real-time urban data is implemented as a technical data-processing pipeline within the server, in which classification outputs are combined with numeric predictions to control selection and ranking of segments. This improves the quality of recommendations and ensures that the response generation process is driven by structured, machine-interpretable criteria rather than purely by human rules.

### H. Interaction With the Terminal and User and Technical Effects

The terminal receives the generated natural-language response sentence and associated visual information from the server and displays them in the messaging application. The terminal may display a text bubble with the response sentence and a thumbnail of a color-coded congestion map. The user can view these outputs to adjust visit plans or routes. The terminal can also provide interaction options, such as buttons to request alternative times or routes, which are converted into new inquiry sentences and transmitted back to the server.

Because the server integrates data acquisition, preprocessing, estimation, visual encoding, and generative text generation into a unified pipeline, the system achieves multiple technical effects. The server reduces redundant data transfers by reusing preprocessed feature data for multiple user inquiries. The server reduces computation overhead by separating heavy model predictions into batch processes, while tailoring generative model prompts using lightweight query analysis. The server reduces network traffic between terminal and server because only compact natural-language messages and compressed visual images are exchanged, and no raw sensor or video data are transmitted to the terminal.

Further, the server improves estimation accuracy compared to simple, rule-based methods by using trained neural networks that capture temporal and spatial correlations. The server improves responsiveness by performing inference on optimized hardware and by caching recent predictions. The server improves data management by using explicit data structures for raw data, features, predictions, and visual information, enabling efficient indexing and retrieval. These aspects represent improvements to the functioning of the computer itself, rather than mere automation of human decision-making.

### I. Variations and Alternative Embodiments

In a variation, the server may use different neural network architectures for the estimation model, such as temporal convolutional networks, graph neural networks that model road networks as graphs, or hybrid models combining recurrent layers with attention mechanisms.

The choice of architecture can be matched to the structure of the urban space and the density of available sensors.

In another embodiment, the server may implement multiple generative AI models specialized for different languages or domains and select among them based on the user's language preference detected from the inquiry sentence. The server may adapt prompt sentence structure depending on the model chosen, ensuring consistent output quality.

In a further embodiment, the server may offload part of the inference tasks to edge devices close to sensors, while maintaining prompt generation and generative model control on a central server. The edge devices can perform initial feature extraction on image data, reducing the volume of data sent over the network and further improving system scalability and latency.

In still another embodiment, the server may generate and send to the terminal not only static images but also structured vector formats or compressed map layers that can be rendered interactively on the terminal, while the core estimation and selection logic remains on the server. This allows flexible client presentations without requiring the terminal to implement complex analysis logic.

In all these embodiments, the server, the terminal, and the user cooperate through specific data structures, algorithms, and model configurations, so that the system as a whole achieves faster, more accurate, and more efficient provision of urban information than conventional architectures. The structured use of a generative AI model via prompt sentences tied to precomputed numeric predictions represents a non-conventional integration that yields technical improvements in computer performance and resource utilization.

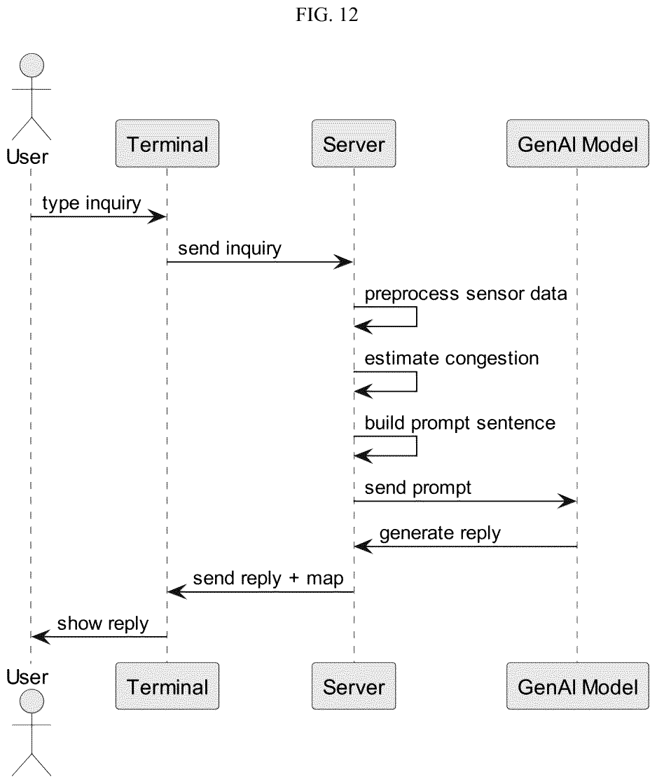

The following describes the processing flow using FIG. 12.

### Step 1:

The server acquires raw urban data from detection devices and imaging devices.

The input is time-series data, such as counts or sensor readings, and image data, such as frames from cameras, each tagged with device identifiers and timestamps. The server opens network connections to the devices or gateways, receives the incoming data streams, and writes each record or frame into storage together with metadata including location identifiers and acquisition times. The output is a set of stored raw data records and image frames ready for preprocessing.

### Step 2:

The server preprocesses the time-series data.

The input is the stored raw time-series data from the detection devices. The server applies noise removal operations, such as moving average filtering or outlier suppression, and performs missing-data compensation by interpolating missing values or marking unreliable segments. The server then computes derived values, such as normalized counts per minute or per segment, by dividing raw counts by standard time intervals and adjusting for sensor sensitivity. The output is a cleaned and normalized time-series dataset in which each record contains a timestamp, a location identifier, and one or more standardized measurement values.

### Step 3:

The server preprocesses the image data.

The input is the stored raw image frames or video frames from the imaging devices. The server decodes the frames into pixel arrays and converts them to a unified color format. The server performs background subtraction or frame differencing to identify moving regions, applies morphological filters to reduce noise, and then executes object-detection routines to classify moving objects into categories such as pedestrians or vehicles. The server counts detected objects and associates these counts with the corresponding camera identifier and time interval. The output is a set of structured object-count records that describe, for each location and time, the numbers and categories of moving objects.

### Step 4:

The server constructs feature vectors for machine-learning analysis.

The input is the cleaned time-series dataset and the structured object-count records. The server aligns data from multiple devices by time and location, merges them into unified records, and computes additional features such as average speed, occupancy ratios, and short-term trends (for example, rate of change in counts). The server packs these values into feature vectors, where each vector corresponds to a particular spatial segment and time interval. The output is a feature dataset in which each feature vector is indexed by location and time and contains multiple numeric dimensions used as input to machine-learning models.

### Step 5:

The server estimates congestion levels and traffic-flow indicators using a trained model.

The input is the feature dataset constructed in Step 4. The server groups feature vectors into sequences representing consecutive time intervals for each segment, normalizes each feature dimension using stored scaling parameters, and arranges the sequences into input tensors. The server performs forward propagation through a trained neural network or other machine-learning model to compute predicted congestion levels, moving-object densities, and traffic-flow indicators for current and future time intervals. The output is a prediction dataset that contains, for each segment and time, numerical estimates of congestion and traffic-flow conditions.

### Step 6:

The server generates visual information representing spatial distributions.

The input is the prediction dataset and geographic metadata linking segments to positions on a map. The server loads a base map of the target urban area and assigns a color to each segment based on the predicted congestion level or traffic-flow category. The server draws colored shapes or overlays on the base map at the positions corresponding to the segments and may annotate them with text labels indicating numerical values or time ranges. The output is one or more annotated map images or equivalent visual objects that depict congestion and traffic distributions over the urban space.

### Step 7:

The user inputs an inquiry sentence via the terminal.

The input is the user's intention to obtain information about urban conditions. The user operates the terminal, launches the messaging application, and types an inquiry sentence such as “Please tell me the current congestion and the best visiting time for cafes in Shibuya.” The terminal captures this text, associates it with a user identifier, a conversation identifier, and optional metadata such as the current location and time. The output is a structured message object containing the inquiry sentence and the metadata, which is sent from the terminal to the server.

### Step 8:

The terminal transmits the inquiry sentence to the server.

The input is the structured message object generated in Step 7. The terminal establishes or uses an existing network connection to the server, encapsulates the message object in a request, and sends it using a communication protocol such as HTTPS. The terminal may display a pending state in the messaging application while awaiting a response. The output is a request received by the server that contains the inquiry sentence and associated metadata.

### Step 9:

The server analyzes the inquiry sentence to extract intent and parameters.

The input is the inquiry sentence and metadata received from the terminal. The server tokenizes the sentence, identifies parts of speech, and detects named entities representing locations, facility types, and time expressions. The server applies an intent-classification routine to determine the type of request, such as congestion inquiry, route inquiry, or safety-related inquiry. The server then converts the extracted entities and intent into a set of parameters, including target area, target facility category, relevant time range, and requested information type. The output is a structured intent object that describes what the user is asking and which prediction and feature data are relevant.

### Step 10:

The server retrieves relevant prediction and visual data.

The input is the structured intent object from Step 9. The server uses the parameters in the intent object to construct database queries against the feature dataset, the prediction dataset, and the visual information store. The server retrieves numeric congestion levels, moving-object densities, traffic-flow indicators, and related timestamps for the target area and time range. The server also retrieves identifiers or file paths to annotated map images corresponding to the same area and time. The output is a response-data object containing the selected numeric data, associated location and time information, and references to visual information.

### Step 11:

The server optionally estimates an emotional state of the user.

The input is the inquiry sentence, optional historical conversation context, and, if available, user profile information. The server applies emotion-analysis software to compute scores for predetermined emotional categories, such as stress, urgency, or preference for quietness. The server interprets these scores according to thresholds; for example, a high stress score may trigger prioritization of low-congestion or high-safety areas. The output is an emotional-state object that includes one or more scores and derived flags indicating whether to emphasize quiet areas, short dwell-time areas, or evacuation-related areas in the response.

### Step 12:

The server selects and ranks candidate areas or facilities.

The input is the response-data object from Step 10 and the emotional-state object from Step 11. The server filters the segments or facilities based on constraints such as maximum allowed congestion level, minimum safety level, or maximum travel distance from the user's location. The server then computes ranking scores that combine congestion indicators, traffic-flow conditions, and emotional-state preferences. For example, the server may assign higher scores to segments with lower predicted congestion when the emotional state suggests a need for a calm environment. The output is a ranked list of candidate areas or facilities, each associated with numeric indicators and descriptive attributes.

### Step 13:

The server constructs a prompt sentence for the generative AI model.

The input is the ranked list of candidate areas or facilities, the numeric prediction values, the emotional-state object, and the original inquiry sentence. The server composes a prompt sentence that embeds a summary of the key numeric results, such as congestion levels and recommended times, and explicit instructions on how the generative AI model should respond. The server includes in the prompt sentence references to the user's request, the selected areas, and any constraints, and may specify language, tone, and length of the answer. The output is a structured prompt sentence that encodes both the user intent and the server's computed data, ready to be input to the generative AI model.

### Step 14:

The server generates a natural-language response using the generative AI model.

The input is the structured prompt sentence from Step 13. The server feeds this text into the generative AI model and configures generation parameters such as maximum number of tokens and decoding strategy. The generative AI model processes the prompt, attends to the embedded numeric data and instructions, and outputs a candidate response sentence that explains the current situation and provides recommendations. The server receives this candidate response and may perform basic checks, such as truncating excessive length or confirming that time expressions remain consistent with the prediction data. The output is a finalized response sentence in natural language suitable for display to the user.

### Step 15:

The server assembles the final response payload for the terminal.

The input is the finalized response sentence and any visual information references from the response-data object. The server constructs a response payload that includes the text of the response, metadata indicating message type, and, if available, links or attachments for annotated map images that visualize congestion and traffic. The server may also include additional structured items, such as suggested follow-up options or identifiers for alternative routes. The output is a complete response payload ready to be transmitted back to the terminal over the messaging channel.

### Step 16:

The server transmits the response payload to the terminal.

The input is the response payload assembled in Step 15. The server sends this payload to the terminal via the established communication channel, associating it with the correct conversation identifier. The server records a log entry that links the inquiry sentence, the internal data used to generate the response, and the generated text, for diagnostic and improvement purposes. The output is a message received by the terminal that contains the natural-language response and any associated visual information.

### Step 17:

The terminal presents the response to the user.

The input is the response payload received from the server. The terminal parses the payload, extracts the response sentence, and displays it as a chat message in the messaging application. If the payload includes an annotated map image or link, the terminal retrieves the image and shows it as a thumbnail or full-screen map accompanying the text. The terminal may also update the user interface to show quick-action controls that allow the user to send follow-up inquiries. The output is a visual and textual presentation on the terminal's display that the user can read and interact with.

### Step 18:

The user decides on a follow-up action and may input an additional inquiry.

The input is the displayed response, including text and any maps or indicators. The user reads the information, interprets the recommended visiting time, route, or safe area, and may decide either to follow the guidance or to refine the request. If the user wishes to refine the request, the user types a new inquiry sentence, such as “Recommend a less crowded cafe in Shibuya that I can visit before 2 p.m. ,” into the messaging application. The output is a new inquiry sentence that is again transmitted from the terminal to the server, causing repetition of the above steps for iterative refinement.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information-provision systems that respond to user inquiries over messaging interfaces typically employ simple rule-based logic or fixed scenario trees. Such systems are limited in their ability to accurately interpret free-form natural language queries, to combine heterogeneous real-time data sources such as traffic-state data and disaster-prevention-related data, and to generate context-appropriate responses that dynamically prioritize user safety over ordinary informational content. As a result, these systems often fail to deliver timely and safety-critical guidance when environmental abnormalities such as natural disasters or large-scale disruptions occur.

In many existing architectures, the processing pipeline is fragmented: one subsystem performs natural language processing, another subsystem independently retrieves traffic-related data, and yet another subsystem may, if present, access disaster-prevention-related data. There is no integrated control mechanism that systematically fuses the analysis result, the domain data, and the behavior of a generative AI model via a structured prompt sentence. Therefore, the generated response may not reflect the latest state information across domains, may omit critical safety information, or may present traffic information and disaster-prevention-related information in an inappropriate order or priority.

Furthermore, typical generative AI deployments treat the AI model as a generic text generator that simply responds to a user query, without a robust, machine-controlled framework for (i) constructing a structured prompt sentence from analyzed user intent and heterogeneous sensor and information-system data, (ii) enforcing prioritization rules such as “safety information must precede convenience information,” and (iii) validating or post-processing the generated text to ensure that such rules have been respected. This lack of systematic orchestration diminishes reliability, creates unpredictable behavior, and impedes the use of generative AI models as dependable components in safety-relevant urban information services.

Additionally, conventional systems do not adequately exploit the output of a natural language processing engine to drive fine-grained, query-specific acquisition of real-time state information from urban infrastructure and external information providers. For example, when a user asks about the safety and traffic conditions for a particular area, existing systems may either provide only generic traffic information or only generic disaster alerts, rather than issuing targeted acquisition requests that reflect the specific user intention and location, merging the returned data into structured form, and using that structure to condition the behavior of the generative AI model.

The technical problem addressed by the present invention is to improve computer technology related to server-side information processing and response generation for messaging-based user interactions, by providing an integrated processing architecture and control logic that: (i) uses a natural language processing engine to derive user intention and location information, (ii) drives targeted acquisition of real-time traffic-state information and disaster-prevention-related information, (iii) constructs a structured prompt sentence that guides a generative AI model to prioritize safety-related content, and (iv) validates and, if necessary, modifies the generated response text before delivering it to the user terminal. By solving this problem, the invention improves the reliability, consistency, and safety-awareness of computer-implemented information-provision services in urban environments.

The specific processing by the specific processing unit 290 of the data processing device 12 in Example 2 is realized by the following means.

The present invention provides a server comprising a processor and at least one memory storing instructions that, when executed by the processor, cause the processor to perform operations comprising: acquiring, as analysis target text, an inquiry message in natural language received from a user terminal via a message communication process; inputting the analysis target text to a natural language processing engine and obtaining an analysis result including information relating to a user intention and information relating to a location; executing, based on the analysis result, a query process to acquire traffic-state information from at least one of an information storage apparatus that stores state information relating to an urban space and an external information providing apparatus; determining, based on the analysis result, whether it is necessary to acquire disaster-prevention-related information from an external information providing apparatus that provides information relating to an environmental abnormality, and, when it is determined that the acquisition is necessary, acquiring the disaster-prevention-related information from the external information providing apparatus; integrating the traffic-state information and the disaster-prevention-related information into structured data aligned by at least the location and a time, and generating a prompt sentence including the structured data and the inquiry message; inputting the prompt sentence to a generative AI model to obtain a response text in natural language; analyzing the response text to confirm that the response text includes information relating to safety assurance based on the disaster-prevention-related information with higher priority than information relating to the traffic-state information, and, when the response text does not satisfy a predetermined safety-prioritization condition, modifying the response text according to a rule set stored in the memory; and transmitting the confirmed or modified response text to the user terminal via the message communication process and causing the user terminal to display the response text. This enables an integrated and computer-implemented control framework in which natural language understanding, heterogeneous state-information acquisition, structured prompt-sentence generation, and generative AI output validation are combined to reliably produce responses that prioritize safety-related content while reflecting real-time urban conditions, thereby improving the technical performance and trustworthiness of server-based information-provision systems.

The term “system” refers to a combination of hardware and software components including at least one server-side information processing apparatus and one or more user terminals that cooperate to execute the claimed processing.

The term “processor” refers to one or more processing units, such as a central processing unit or a graphics processing unit, that execute instructions to perform the functions described in the claims.

The term “memory” refers to any non-transitory computer-readable storage medium, such as semiconductor memory, magnetic storage, or optical storage, that stores instructions and data for execution by the processor.

The term “information processing apparatus” refers to an electronic device, such as a server or computing node, that includes the processor and the memory and that performs message communication, analysis, data acquisition, and response generation.

The term “user terminal” refers to an endpoint device operated by a user, such as a smartphone, tablet, or personal computer, that sends inquiry messages and receives response messages via a messaging interface.

The term “message communication process” refers to a communication procedure, such as a messaging protocol or application-layer messaging service, by which the information processing apparatus exchanges text messages with the user terminal.

The term “inquiry message” refers to a message in natural language transmitted from the user terminal to the information processing apparatus to request information relating to a situation, such as traffic conditions or safety.

The term “natural language” refers to a human language, such as a spoken or written language used by people, in contrast to a formal programming language or a purely symbolic representation.

The term “analysis target text” refers to text data extracted from the inquiry message that is input to a natural language processing engine for analysis.

The term “natural language processing engine” refers to a software or hardware module that analyzes natural language text to derive linguistic or semantic information, such as intent, entities, or location information.

The term “analysis result” refers to structured information output by the natural language processing engine, including at least information relating to a user intention and information relating to a location.

The term “user intention” refers to a purpose or objective inferred from the inquiry message, such as a request for traffic information, safety information, or route guidance.

The term “information relating to a location” refers to data indicating a geographic area or place, such as a city, district, facility, or route, identified from the inquiry message.

The term “query process” refers to a sequence of operations by which the processor generates and issues a request to another apparatus or service in order to acquire state information.

The term “traffic-state information” refers to information indicating a state of movement of vehicles or people in an area, such as congestion level, travel time, incidents, or road closures.

The term “information storage apparatus” refers to a storage system, such as a database server or data repository, that stores state information relating to an urban space, including traffic-state information.

The term “external information providing apparatus” refers to an external system or service, such as a remote server or web service, that supplies state information, including traffic-state information or disaster-prevention-related information.

The term “urban space” refers to a geographically defined area that includes transportation infrastructure, facilities, and other elements of a built environment.

The term “environmental abnormality” refers to an abnormal or hazardous condition in the environment, such as a natural disaster, severe weather, or large-scale disruption affecting safety.

The term “disaster-prevention-related information” refers to information relating to prevention, mitigation, or response to an environmental abnormality, such as warnings, alerts, evacuation advisories, or hazard levels.

The term “structured data” refers to data organized according to a predefined schema or format, such as records, fields, or key-value pairs, enabling systematic processing and integration.

The term “prompt sentence” refers to a text or textual structure supplied as input to a generative AI model, the text including instructions, context, and data for controlling the behavior of the generative AI model.

The term “generative AI model” refers to a machine-learned model, such as a large language model, that generates output text in natural language in response to input including a prompt sentence.

The term “response text” refers to natural language text generated by the generative AI model based on the prompt sentence and any included structured data.

The term “safety assurance” refers to guidance or information provided to a user for reducing risk or enhancing safety in relation to an environmental abnormality, such as advice on evacuation or route avoidance.

The term “safety-prioritization condition” refers to a condition or rule specifying that information relating to safety assurance must be included in the response text with higher priority or earlier presentation than non-safety information such as ordinary traffic-state information.

The term “rule set” refers to a collection of predefined rules or conditions stored in the memory and used by the processor to modify or validate the response text.

The term “real-time traffic-state information” refers to traffic-state information that reflects a current or near-current state of traffic in an urban space, obtained within a time interval suitable for immediate decision-making.

The term “query conditions” refers to parameters or criteria, such as location, time, and type of state information, that define a request to an information storage apparatus or external information providing apparatus.

The term “control condition” refers to an instruction or constraint embedded in the prompt sentence that specifies how the generative AI model should structure or prioritize content in the response text.

The term “normal state” refers to a situation in which no environmental abnormality relevant to the user's inquiry is detected in the acquired state information.

The term “state in which an environmental abnormality occurs” refers to a situation in which the acquired disaster-prevention-related information indicates the presence of an environmental abnormality in the relevant area.

The term “evacuation action” refers to behavior recommended to a user to move from a current location to a safer location in response to an environmental abnormality.

The term “route change” refers to modification of a planned travel route, such as selecting an alternative path or mode of transportation, based on traffic-state information and disaster-prevention-related information.

The term “display” refers to causing a visual user interface on the user terminal to present the response text so that the user can read the content.

In one embodiment, a server includes a processor and a memory storing instructions that implement the claimed functions in cooperation with one or more terminals operated by users. The server executes an operating system such as a server-class operating system, and application software implemented, for example, in a general-purpose programming language. The terminal executes a messaging application implemented on an operating system for a mobile device or a personal computer.

The server uses communication hardware, such as a network interface controller, to communicate with the terminal via a packet-switched communication network. The server sends and receives text messages encoded in a structured data format over a transport protocol such as HTTP or HTTPS. The terminal uses a display device, an input device such as a touchscreen or keyboard, and a communication module such as a wireless communication module to present a user interface and to transmit user-entered text to the server.

The server uses a natural language processing engine to analyze an inquiry message in natural language received from the terminal. In one example, the server calls a commercial cloud-based natural language processing API such as a language analysis API provided by a cloud platform, for example, a cloud natural language API. In another example, the server executes a local natural language processing library implemented using a deep neural network model constructed with a machine learning framework such as TensorFlow or PyTorch.

The server converts the inquiry message into an internal character encoding such as UTF-8 and normalizes the text using Unicode normalization. The server tokenizes the inquiry message into word or subword units and converts the tokens into integer identifiers using a vocabulary table. The server provides these identifiers as inputs to the natural language processing engine. The natural language processing engine internally applies a neural network architecture, for example a transformer encoder including multiple self-attention layers, layer normalization, and feed-forward sublayers. The natural language processing engine computes contextual embeddings for each token and outputs classification scores representing candidate user intentions and candidate locations. The server interprets these scores as a probability distribution and selects an intention label and a location entity based on maximum probability or a threshold-based rule.

The server stores the selected intention and the location entity as structured fields in a data structure in memory. The data structure may be implemented as a key-value map or as an object instance containing fields such as intent_code, location_id, and confidence_score. The server uses this data to generate query conditions for acquiring traffic-state information and, if necessary, disaster-prevention-related information.

The server accesses an information storage apparatus that stores state information relating to an urban space. In one embodiment, the information storage apparatus is a relational database management system such as a SQL-based database storing tables that represent road segments, congestion levels, and incident information. The server generates a query string including a location identifier, a time range, and requested attributes, and sends the query to the information storage apparatus. The server receives a result set including records that contain fields such as road_id, congestion_level, travel_time, and closure_flag. The server converts the result set into an internal structured format such as an array of records or a list of objects.

The server also communicates with an external information providing apparatus that supplies disaster-prevention-related information. The external information providing apparatus may be a remote web service providing weather alerts, disaster warnings, and evacuation advisories. The server constructs an HTTP request including parameters such as geographic coordinates or an area code and a time parameter. The server sends the request and receives a response in a structured text format such as JSON or XML. The server parses the response and extracts fields such as warning_type, severity_level, affected_area, and recommended_action. The server stores these fields in a structured data object in memory.

The server integrates the traffic-state information and the disaster-prevention-related information into a unified structured data representation. The server associates each traffic record with any disaster-prevention-related record whose affected area overlaps the location of the traffic record and whose time interval overlaps the current time. The server may represent this integration as an in-memory graph or as a composite object that contains nested lists of traffic segments and associated disaster alerts. The server assigns priority flags to elements of this structure based on rules stored in the memory. For example, the server sets a high-priority flag when a traffic segment is in an area with a severe warning level.

The server uses the unified structured data and the original inquiry message to generate a prompt sentence for a generative AI model. The generative AI model is, for example, a large language model based on a transformer architecture including a stack of encoder and decoder layers with multi-head self-attention, cross-attention, and feed-forward networks. The generative AI model is pre-trained on a large corpus of text data using a language modeling objective such as next-token prediction or masked language modeling, and optionally fine-tuned on domain-specific corpora for traffic and disaster information explanations.

The server constructs a prompt sentence as a single continuous text or as a sequence of textual segments. In one example, the server uses the following prompt sentence:
“The user has sent the following message: ‘Is it safe to drive to Shinjuku now, and how is the traffic?’
Parsed intent: commute_safety_and_traffic.
Traffic data:
Main roads around Shinjuku: heavy congestion on some routes, moderate congestion on others.
Several road segments are closed due to an earlier incident.
Disaster-prevention-related data:
Heavy rain warning in the area around Shinjuku.
Risk of flooding on low-lying roads.

You are an assistant that explains traffic and disaster information to ordinary users.
Task:
1. First, clearly explain any safety-critical information based on the disaster-prevention-related data, and provide specific advice on evacuation or route avoidance if necessary.
2. Then summarize the current traffic situation around Shinjuku in simple, natural language, mentioning congested areas, road closures, and recommended alternative routes.
3. Answer concisely so that the user can make a quick decision.
4. Respond in Japanese.”

The server also supports another prompt sentence for normal situations without environmental abnormalities, such as:

“The user has sent the following message: ‘Tell me the current traffic situation around Tokyo Station.’
Parsed intent: traffic_status.
Traffic data:
Current congestion level around Tokyo Station.
Estimated travel time on main routes.

You are an assistant that explains urban traffic information to ordinary users. Task:
1. Provide a concise explanation of the current traffic situation around Tokyo Station.
2. Mention congested areas and suggest alternative routes if appropriate.
3. Respond in Japanese.”

The server embeds the structured data into the prompt sentence by serializing key fields in a human-readable form. The server applies predefined templates to ensure that the generative AI model consistently receives the user intention, the location, the traffic-state information, and the disaster-prevention-related information in a fixed order. This non-conventional prompt structure reduces ambiguity and improves the reliability of the model's output.

The server sends the prompt sentence to the generative AI model by encoding the text into a sequence of token identifiers using a tokenizer associated with the model. The generative AI model converts each token identifier into an embedding vector and processes the sequence through multiple transformer layers. Each transformer layer applies self-attention to compute weighted combinations of token embeddings based on learned attention weights, and applies feed-forward transformations with non-linear activation functions. The generative AI model generates a probability distribution over possible next tokens at each time step and selects tokens according to a decoding strategy such as greedy decoding, beam search, or nucleus sampling with a specified temperature and top-p parameter.

The server receives the generated token sequence from the generative AI model and converts the sequence back into a text string. The server then analyzes the generated text to verify compliance with safety-prioritization conditions. The server searches the generated text for patterns that indicate the presence of disaster-prevention-related content, such as mentions of warnings, evacuation, or specific risk descriptions. The server also checks the relative position of these mentions in the text to confirm that safety-related content appears before ordinary traffic-related content when the disaster-prevention-related information indicates a risk.

The server maintains a rule set in memory specifying conditions for acceptable responses. For example, the rule set may require that, when a severe disaster alert is detected, the generated text must include at least one sentence describing the alert and at least one sentence recommending an action to the user, such as avoiding certain areas or using alternative transportation. If the generated text does not satisfy these conditions, the server modifies the text by inserting, reordering, or supplementing sentences using template-based operations that draw on the structured data stored in memory. This post-processing step ensures that the final response complies with safety-prioritization rules even if the generative AI model output is incomplete.

The terminal receives the final response via the messaging interface. The terminal decodes the message, renders the text on a display, and may use local caching to preserve the message history. The user reads the response and can make an informed decision about travel and safety. The system therefore uses the integrated server processing to control information flow to the user in a manner not practically achievable by manual human processing in real time. The server configuration and data flow improve computer technology in several ways. First, the server reduces processing time by structuring data and controlling the generative AI model with a prompt sentence that is tailored to the user intention and location. The server avoids repeated full-corpus searches by the model by pre-selecting relevant state information and compressing it into structured text form. This selective conditioning reduces the computational load on the generative AI model, minimizing token length and inference time compared with naive approaches that supply large, unfiltered datasets to the model.

Second, the server improves accuracy of intention recognition and data retrieval by combining deep neural network-based natural language processing with rule-based mapping to domain-specific intent codes and location identifiers. The server encodes learned distributional semantics through the natural language processing engine and explicit, non-neural rules for mapping output scores to system-level commands, thereby producing a stable and predictable control signal for subsequent data acquisition operations.

Third, the server improves data management by normalizing and integrating heterogeneous data sources into a unified structured representation before calling the generative AI model. This integration step uses explicit algorithms for spatial and temporal alignment of traffic-state information and disaster-prevention-related information, such as matching geographic coordinates, area codes, or route identifiers. As a result, the generative AI model receives a consistent and compressed representation of urban conditions, which improves the coherence and specificity of the generated text.

Fourth, the server implements a non-conventional combination of machine-learned generation and deterministic rule enforcement. The server does not simply replace human authorship with automated text generation. Instead, the server defines explicit safety-prioritization conditions and a rule set that operates on model outputs. This architecture constrains the model's behavior within a safety-aware framework and thereby enhances trustworthiness, reduces error rates related to missing safety information, and creates a measurable technical improvement over conventional systems that rely solely on unconstrained model output.

The generative AI model itself may be trained using gradient-based optimization such as stochastic gradient descent or an adaptive optimizer. The training process uses an error function such as cross-entropy between predicted token distributions and reference tokens. The model's parameters, including weight matrices and bias terms within the transformer layers, are updated based on gradients computed by backpropagation. The training data may include domain-specific samples of traffic and disaster explanations, which the server or an offline training system prepares by augmenting generic text corpora with synthetic and human-labeled examples. Data augmentation techniques such as paraphrasing, back-translation, and controlled insertion of structured data descriptions may be used to improve robustness and diversity.

The server may implement multiple embodiments or variants. In one variant, the server executes the generative AI model locally on a dedicated server node equipped with hardware accelerators such as graphics processing units or tensor processing units. In another variant, the server accesses the generative AI model through an external model-hosting service via a secure network connection. In still another variant, the server uses a smaller, locally hosted generative model for low-latency scenarios and a larger, remotely hosted model for high-accuracy scenarios, dynamically selecting between them based on network conditions or query complexity.

The server may also implement alternative natural language processing engines. In a first embodiment, the server uses a remote cloud-based natural language analysis service. In a second embodiment, the server executes an on-premise transformer-based classifier trained on localized language data. In a third embodiment, the server combines a rule-based keyword extractor with a neural network classifier to reduce computational cost for simple queries while maintaining high accuracy for complex queries that require full neural analysis. The server can apply different control conditions in the prompt sentence depending on the context. For example, in a normal state with no detected environmental abnormality, the server may use a prompt sentence that instructs the generative AI model to present concise traffic summaries and route suggestions. In a state in which an environmental abnormality occurs, the server may use a prompt sentence that instructs the generative AI model to first explain the nature and severity of the abnormality, then to propose evacuation actions or route changes, and only then to discuss secondary information such as typical congestion. This dynamic control of prompt content and structure is performed algorithmically by the server based on the analysis result and the integrated structured data, and is not a simple static template substitution.

The terminal can vary as well. In one embodiment, the terminal is a smartphone executing a messaging application provided by a communication service provider. In another embodiment, the terminal is a vehicle-mounted information device integrated into a navigation system. In this case, the terminal can use the server's response to automatically adjust a suggested driving route, and the display can show highlighted sections of roads that the server identifies as high-risk based on the disaster-prevention-related information. This integration of server-generated information with vehicle navigation provides a direct technical use of the processed data in controlling machine behavior, such as modifying a planned path.

The server thereby realizes a technical improvement in computer-based messaging systems by combining deep learning-based natural language understanding, structured multi-source data integration, controlled prompt sentence generation for a generative AI model, and rule-based validation and modification of model outputs. This combination produces faster and more accurate responses, reduces computational and communication burdens through selective data acquisition and structured prompts, and ensures that critical safety information is prioritized in a consistent, machine-enforceable manner.

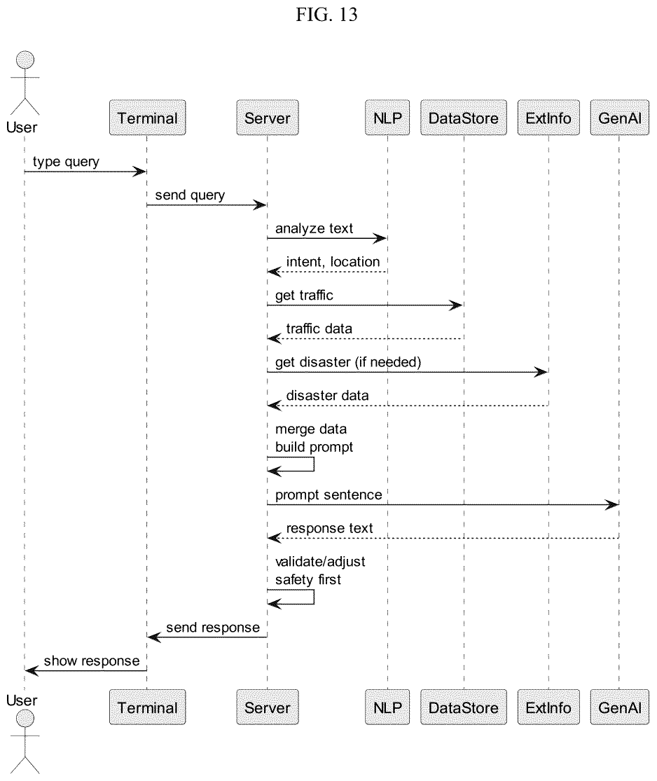

The following describes the processing flow using FIG. 13.

### Step 1:

The user inputs an inquiry message.

The user operates the terminal and enters a natural language message such as “Is it safe to drive to Shinjuku now, and how is the traffic?” into a messaging application.

The terminal receives keyboard or touchscreen events as input, constructs a message object including user identifier, timestamp, and text string, and displays the message in the local chat view.

The terminal outputs the constructed message object and transmits it to the server over a network using a messaging protocol such as HTTPS.

### Step 2:

The server receives and normalizes the inquiry message.

The server takes, as input, the message object from the terminal, extracts fields including the text string, user identifier, and timestamp, and logs these fields in a logging subsystem.

The server performs data processing by converting the text string to a standard character encoding such as UTF-8 and applying Unicode normalization to remove control characters and unify character forms.

The server outputs a cleaned text string and an associated request context structure that includes the user identifier, timestamp, and a unique request identifier.

### Step 3:

The server analyzes the inquiry message using a natural language processing engine.

The server uses the cleaned text string as input and sends it to a natural language processing engine, for example a cloud-based language analysis API or a local transformer-based classifier.

The server performs data computation by tokenizing the text, mapping tokens to vocabulary indices, and causing the natural language processing engine to apply neural network layers (self-attention, feed-forward networks) to compute probabilities for candidate user intentions and candidate locations.

The server receives, as output, an analysis result that includes an intent label, a location entity, and confidence scores, and stores this analysis result in the request context structure.

### Step 4:

The server determines whether disaster-prevention-related information is needed.

The server takes the analysis result as input and reads the intent label and location entity. The server performs rule-based processing by comparing the intent label and any extracted keywords (such as “safe,” “disaster,” “warning”) with a configuration table that specifies which intents and terms require disaster-prevention-related data.

The server outputs a Boolean flag indicating whether disaster-prevention-related information is required and updates the request context structure with this flag.

### Step 5:

The server generates query conditions for traffic-state information.

The server uses, as input, the location entity, the intent label, and the current time. The server performs data processing by mapping the location entity to an internal location identifier, determining a search radius and time window, and constructing query parameters including location_id, radius, and time_range.

The server outputs a traffic query condition structure and stores it in the request context structure.

### Step 6:

The server acquires traffic-state information from an information storage apparatus.

The server takes the traffic query condition structure as input and formats a database query or API request that specifies the required fields such as congestion level, travel time, and road closure status.

The server performs data retrieval operations by transmitting the query to an information storage apparatus such as a relational database or city data service and receiving a result set containing records of road segments and their states.

The server outputs a structured traffic-state dataset, for example a list of records each including road_id, congestion_level, travel_time, and closure_flag, and attaches this dataset to the request context structure.

### Step 7:

The server determines and acquires disaster-prevention-related information when necessary.

The server uses, as input, the Boolean flag indicating whether disaster-prevention-related information is required and the location entity.

When the flag is true, the server performs data retrieval operations by constructing a request to an external information providing apparatus, including geographic parameters and time parameters, and sending the request over the network.

The server receives, as output, a dataset of disaster-prevention-related records including fields such as warning_type, severity_level, affected_area, and recommended_action, and stores this dataset in the request context structure.

When the flag is false, the server outputs an empty or null disaster-prevention-related dataset and records this state in the request context structure.

### Step 8:

The server integrates traffic-state information and disaster-prevention-related information.

The server takes the traffic-state dataset and the disaster-prevention-related dataset as input. The server performs data processing by aligning records based on spatial and temporal keys, such as matching road coordinates or area codes with affected areas, and matching timestamps or time windows. The server assigns priority flags to traffic segments that fall within areas of high severity_level.

The server outputs an integrated structured data object that associates each traffic segment with zero or more disaster alerts and includes priority indicators, and stores this integrated object in memory as part of the request context structure.

### Step 9:

The server constructs a prompt sentence for a generative AI model.

The server uses, as input, the original inquiry message, the analysis result (intent and location), and the integrated structured data object.

The server performs text composition by selecting a template based on whether disaster-prevention-related data is present, inserting the user message, the parsed intent, and summarized traffic and disaster information into the template, and appending explicit instructions that specify content order and safety prioritization.

The server outputs a prompt sentence such as:

“The user has sent the following message: ‘Is it safe to drive to Shinjuku now, and how is the traffic?’
Parsed intent: commute_safety_and_traffic.
Traffic data: description of congestion, closures, and travel time.
Disaster-prevention-related data: description of warnings, severity, and affected areas.

You are an assistant that explains traffic and disaster information to ordinary users.
Task:
1. First, clearly explain any safety-critical information based on the disaster-prevention-related data, and provide specific advice on evacuation or route avoidance if necessary.
2. Then summarize the current traffic situation in simple, natural language, mentioning congested areas, road closures, and recommended alternative routes.
3. Answer concisely so that the user can make a quick decision.
4. Respond in Japanese.”

The server stores this prompt sentence in the request context structure.

### Step 10:

The server generates a response text using the generative AI model.

The server takes the prompt sentence as input and tokenizes the text using a tokenizer associated with the generative AI model, converting characters into a sequence of token identifiers.

The server performs model inference by sending the token identifiers to the generative AI model, which applies multiple transformer layers, attention mechanisms, and feed-forward operations to compute probability distributions over next tokens and to generate an output token sequence according to a decoding strategy.

The server converts the output token sequence back into a natural language text string and outputs this string as a preliminary response text, storing it in the request context structure.

### Step 11:

The server validates and, if necessary, modifies the response text based on safety-prioritization rules.

The server uses, as input, the preliminary response text, the disaster-prevention-related dataset, and a rule set stored in memory.

The server performs text analysis by scanning the response text for mentions of warnings, evacuation, or risk-related phrases, and calculates the position of such content relative to descriptions of traffic conditions. The server compares these findings with the rule set, which specifies that safety-related information must appear and must precede ordinary traffic information when disaster-prevention-related data indicates risk.

When the response text satisfies the rules, the server outputs the validated response text without change. When the response text does not satisfy the rules, the server outputs a modified response text generated by inserting or reordering sentences derived from templates and the integrated structured data, thereby enforcing the safety-prioritization conditions.

### Step 12:

The server transmits the final response text to the terminal.

The server takes, as input, the validated or modified response text and the user identifier from the request context structure.

The server performs message construction by creating an outgoing message object containing the user identifier, the response text, and metadata such as a response timestamp. The server encodes this object into a suitable format and sends it over the network using the messaging protocol.

The server outputs a successful transmission status and records the response text and status in a log for traceability.

### Step 13:

The terminal receives and displays the response text.

The terminal uses, as input, the message object received from the server via the messaging application backend.

The terminal performs data processing by decoding the message object, extracting the response text, and updating the user interface to add a new message bubble that contains the server's response. The terminal may also adjust the scroll position so that the new message is visible to the user.

The terminal outputs the rendered response on the display, allowing the user to read the safety information and traffic details.

### Step 14:

The user reviews the response and may initiate a follow-up inquiry.

The user takes the displayed response as input and interprets the provided safety guidance and traffic conditions.

The user performs decision-making such as choosing to delay a trip, change a route, or use a different transportation mode, and may then operate the terminal to input a follow-up message such as “Suggest a safer route to Shinjuku by train.”

The user outputs a new inquiry that the terminal again sends to the server, causing the processing flow to repeat from Step 2 onward.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information providing systems that deliver urban or regional information to end users typically rely on static rule-based engines or simple keyword matching to respond to user queries. Such systems suffer from several technical limitations. First, the server-side processing pipeline is not capable of flexibly interpreting diverse natural language inputs; as a result, the server often misidentifies user intent and cannot reliably map unstructured text to appropriate machine-level queries. Second, conventional architectures treat external data acquisition (for example, traffic conditions, facility information, or congestion levels) as a fixed set of pre-programmed API calls, which prevents the system from adapting at runtime to new data sources or complex combinations of conditions. Third, existing systems usually ignore the user's emotional state at the computation layer, so server-side selection and ranking logic cannot dynamically filter or prioritize information based on the user's emotional condition. This leads to technically suboptimal use of network bandwidth and processing resources, because the server may retrieve and transmit large volumes of data that are not contextually useful to the user.

Furthermore, prior systems typically separate natural language response generation from the underlying data retrieval and decision logic. The server does not use a unified generative model to jointly (i) determine what data to request from external devices and (ii) convert structured data into a coherent, context-aware natural language response. Because of this separation, the internal representation of user intent, external data, and emotion is fragmented across multiple subsystems, resulting in increased latency, redundant processing, and difficulty in scaling to heterogeneous information sources. In addition, when user terminals are mounted on moving bodies, such as vehicles or robots, conventional servers are not architected to generate emotion-aware route information and to feed that route information back into an on-board guidance unit in a consistent and programmable way.

Accordingly, there is a need for an improved computer-implemented system in which a server processor is configured to (i) parse natural language inquiries to extract intent and location information, (ii) generate structured prompt sentences for a generative AI model that direct external information devices to provide urban information, (iii) apply emotion-aware filtering and ranking using the generative AI model, and (iv) output machine-usable selection results and natural language responses to user terminals, including terminals installed in moving bodies. By tightly integrating prompt sentence generation, generative AI-based reasoning, external data access, and emotion-aware filtering within the server, the technical operation of the information providing system can be improved in terms of accuracy, adaptability, processing efficiency, and real-time responsiveness.

The specific processing by the specific processing unit 290 of the data processing device 12 in Application Example 2 is realized by the following means.

The present invention provides a server comprising a processor configured to receive, via a messaging communication unit, a natural language inquiry from a user terminal, analyze the natural language inquiry using a natural language processing technique to extract intent information indicating a user request and current location information of the user, generate a first prompt sentence for input to a generative AI model based on an analysis result including the intent information and emotion information indicating an emotional state of the user, and, in accordance with the first prompt sentence, instruct one or more external information providing devices including at least one of a geographic information providing device, a route guidance device, an environment information acquisition device, and an urban information management device to provide urban information including at least one of traffic condition information, facility information, congestion information, and safety-related information, filter the urban information using the generative AI model based on the emotion information and the intent information, select at least one candidate facility or at least one candidate route from among a plurality of candidate facilities or a plurality of candidate routes in accordance with the emotional state and the user request, generate, based on a second prompt sentence supplied to the generative AI model, response information in natural language corresponding to a selection result, and transmit the response information and the selection result to the user terminal so that the user terminal presents the response information and the selection result to the user via at least one of a display unit and an audio output unit. This enables the server to implement an integrated, computer-implemented pipeline in which natural language understanding, emotion-aware selection logic, external data acquisition, and natural language response generation are coordinated through prompt sentences to a generative AI model, thereby improving accuracy and efficiency of information retrieval, reducing unnecessary data transmission, and providing contextually appropriate recommendations and route guidance, including for user terminals mounted on moving bodies.

The term “processor” refers to one or more hardware computing elements configured to execute machine-readable instructions, including a central processing unit, a graphics processing unit, a digital signal processor, or any combination thereof.

The term “user terminal” refers to an information processing device operated by a user, including but not limited to a handheld device, a vehicle-mounted device, a wearable device, or any other communication-capable device having an input unit and an output unit.

The term “messaging communication unit” refers to a hardware and software communication interface configured to send and receive messages between the server and the user terminal using a messaging protocol, a communication network, and an application-layer messaging service.

The term “natural language inquiry” refers to a message expressed in a human language, such as text or speech converted into text, that is transmitted from the user terminal to the server to request information or a service.

The term “natural language processing technique” refers to a computational technique for analyzing human language text, including tokenization, part-of-speech tagging, syntactic parsing, semantic analysis, intent classification, and related linguistic processing.

The term “intent information” refers to information indicating a semantic purpose of the natural language inquiry, including a classification or representation of what type of information or operation the user is requesting.

The term “current location information” refers to data indicating a geographical position associated with the user or the user terminal, including coordinates, an address, or a region identifier obtained from a positioning system or other location service.

The term “emotion information” refers to information representing an estimated emotional state of the user, including a label, a score, or a distribution indicating, for example, stress, fatigue, joy, neutrality, or other affective states.

The term “generative AI model” refers to an artificial intelligence model configured to generate output data, including text, instructions, or other structured information, in response to input data such as a prompt sentence, using a machine learning architecture such as a neural network language model.

The term “prompt sentence” refers to text information supplied as input to the generative AI model, the text information specifying at least one of context, instructions, constraints, or data to be used by the generative AI model when generating an output.

The term “external information providing device” refers to an information processing system or service external to the server that is capable of supplying data in response to a request, including but not limited to a geographic information providing device, a route guidance device, an environment information acquisition device, and an urban information management device.

The term “geographic information providing device” refers to an information system configured to provide geographical data, including map data, coordinates, place data, and other location-related information.

The term “route guidance device” refers to an information system configured to generate or provide travel route information between locations and, in some cases, to output guidance instructions for navigating along a route.

The term “environment information acquisition device” refers to an information system configured to collect and provide data relating to an environment, including congestion levels, sensor measurements, image-derived information, weather data, or other environmental conditions.

The term “urban information management device” refers to an information system configured to store, manage, and provide urban-related data, including traffic condition information, facility information, congestion information, and safety-related information associated with a city or region.

The term “urban information” refers to information relating to an urban or regional environment, including traffic condition information, facility information, congestion information, and safety-related information.

The term “traffic condition information” refers to data representing a state of traffic on a transportation network, including congestion levels, travel times, incidents, road closures, and other traffic-related parameters.

The term “facility information” refers to data describing a physical facility, including a category, a name, a geographic location, an address, operating hours, ratings, and other descriptive attributes.

The term “congestion information” refers to data indicating a density or crowd level of persons, vehicles, or other entities in a facility, a route, or an area, including indicators derived from sensors or observation.

The term “safety-related information” refers to data relating to safety conditions in an area, including disaster information, hazard information, evacuation information, crime-related information, and other security-relevant data.

The term “candidate facility” refers to a facility that is considered as a potential recommendation to the user among a plurality of facilities identified based on the intent information and the urban information.

The term “candidate route” refers to a travel path between locations that is considered as a potential route to be provided to the user among a plurality of routes computed or obtained from a route guidance device.

The term “selection result” refers to information indicating at least one candidate facility or at least one candidate route that has been chosen from among a plurality of candidates based on at least the intent information and the emotion information.

The term “response information” refers to natural language text generated for presentation to the user, the text describing at least the selection result and optionally including explanatory content and recommendations.

The term “display unit” refers to a hardware component configured to visually present information to a user, including but not limited to a liquid crystal display, an organic light-emitting diode display, a projection device, or a similar visual output device.

The term “audio output unit” refers to a hardware component configured to audibly present information to a user, including but not limited to a speaker, an earphone, or a headset used with text-to-speech or audio playback.

The term “structured data” refers to data organized according to a predefined format, such as a table, a record, or a hierarchical structure, that represents information including the urban information, the intent information, the emotion information, or the current location information.

The term “moving body” refers to a mobile apparatus capable of movement in an environment, including a vehicle, a robot, or another mobile platform.

The term “route information” refers to data that defines a travel route of a moving body, including at least a sequence of positions, links, or waypoints, and optionally including guidance instructions or estimated travel times.

The term “route guidance unit” refers to a component of the moving body configured to receive route information and to perform at least one of generating guidance instructions and controlling movement of the moving body along a specified route.

The term “automatic travel control” refers to a function in which the movement of a moving body is controlled at least in part by an automated control system based on route information or environmental conditions.

The term “route guidance control” refers to a function in which guidance instructions such as directions, turns, or maneuvers are generated and provided to assist the movement of a moving body along a specified route.

In one embodiment, a server cooperates with one or more user terminals to implement the claimed system. The server includes at least one processor, a memory storing programs and data structures, and a network interface connected to a communication network. The user terminal includes at least one processor, a memory, a display unit and/or an audio output unit, an input unit, and optionally a positioning unit and vehicle interface circuitry when the user terminal is mounted on a moving body.

Server executes a plurality of software modules stored in the memory. These modules include at least a messaging interface module, a natural language processing module, an emotion analysis module, a prompt generation module, a generative AI module interface, an external data acquisition module, a candidate selection module, and a response generation and delivery module. Server may execute these modules in the form of one or more processes running on a general-purpose computer platform. The general-purpose computer platform may be implemented by a central processing unit and a graphics processing unit, a main memory, a nonvolatile storage device, and a network interface controller. Server may further include an accelerator such as a graphics processing unit configured to efficiently execute neural network inference.

Terminal executes a client application providing a messaging user interface. Terminal may be a handheld device, a vehicle-mounted navigation unit, or a wearable device. Terminal communicates with the server via a messaging communication unit which may use standard communication protocols such as HTTP, WebSocket, or a messaging protocol on top of a transport protocol. Terminal acquires current location information from a positioning unit such as a satellite-based positioning receiver or a network-based positioning service, and attaches the current location information to messages transmitted to server.

Server uses the natural language processing module to transform an input natural language inquiry into machine-usable intent information. The natural language processing module may be implemented using an off-the-shelf language processing framework such as a tokenization engine, a part-of-speech tagger, and a semantic parser. In one embodiment, server uses a transformer-based encoder model that converts a tokenized representation of the natural language inquiry into a fixed-length or variable-length embedding vector. The embedding vector encodes contextual information about the inquiry. Server then uses a classification layer implemented as a fully connected neural network with a softmax output to map the embedding vector to intent labels such as “traffic information request,” “nearby facility search,” or “relaxation place request.” By using the transformer-based encoder and classification layer, server improves the recall and precision of intent recognition across diverse natural language expressions compared with simple keyword matching.

Server uses the emotion analysis module to derive emotion information from the same or related natural language content. In one embodiment, server uses a neural network trained to classify affective states. The neural network may be constructed as a recurrent neural network, a transformer network, or a convolutional neural network that ingests token sequences and outputs a probability distribution over emotion categories such as “neutral,” “stressed,” “tired,” “excited,” and “relaxed.” Server trains this model using supervised learning on labeled text data. During training, server uses a loss function such as cross-entropy between predicted emotion probabilities and ground-truth labels, and updates model weights by a gradient descent algorithm such as stochastic gradient descent or an adaptive optimization algorithm. Server may augment the training data by paraphrasing or synonym replacement to improve robustness. By deriving emotion information in this way, server creates a quantitative measure of user emotion that can be further processed algorithmically, rather than merely annotating messages manually.

Server uses the prompt generation module to construct a prompt sentence to be provided to a generative AI model. The prompt sentence is text information that encodes, in a unified format, at least intent information, emotion information, current location information, and, in some embodiments, structured data representing previously obtained urban information. In one embodiment, server builds the prompt sentence by concatenating predefined template strings and serialized key-value pairs representing the extracted information. For example, server may generate a prompt sentence such as:

“The user says: ‘Let me know the current traffic situation.’. Intent: GET_TRAFFIC_INFO. Emotion: NEUTRAL. Current location: [35.6812, 139.7671]. As an urban assistant, decide which traffic information to obtain from external devices and how to summarize current congestion and an optimal route in polite Japanese.”

In another example, server may generate a prompt sentence such as:

“User says: ‘I'm tired today.’. Intent: GET_RELAXING_PLACE. Emotion: TIRED. Current location: [35.68, 139.76]. As a city guide, select 2-3 nearby relaxing places such as spas, quiet cafes, or parks, using available facility and congestion data, and propose them in Japanese with brief explanations.”

Server then supplies this prompt sentence to the generative AI model via the generative AI module interface. The generative AI module interface may communicate with a neural network language model that implements a transformer-based generative architecture. The generative AI model processes the prompt sentence using multiple attention layers that model dependencies across tokens and produces an output sequence token by token. Server may host this generative model locally, or may call a remote inference service. In either case, server transmits the prompt sentence as input and receives generated text as output. Server uses the external data acquisition module to acquire urban information from external information providing devices in accordance with control information derived from the generative AI model output or from preconfigured mappings between intent labels and external data sources. For example, server may parse the generative AI output for explicit instructions such as “obtain traffic information for a 5 km radius around [lat, lon] and compute alternative routes that avoid segments with congestion index above a threshold.”

Server translates such instructions into concrete requests to external devices. These external devices may include a geographic information system, a route computation service, an environment information acquisition system that provides congestion values derived from sensors or cameras, and an urban information management database. Each external device may expose data via structured responses such as records including geographic coordinates, timestamps, congestion indices, facility attributes, and safety flags.

Server stores the retrieved urban information in a structured data format in the memory. The structured data format may be implemented as records with fields such as place identifier, category label, location coordinates, estimated travel time to reach the place, an aggregated user rating, and a congestion score. For route-related information, server may store lists of waypoints or segments, each associated with travel time, congestion level, and safety indicators. By using such structured representations, server can compare, filter, and score multiple candidate facilities and routes by numerical computation rather than by qualitative description.

Server uses the candidate selection module to perform emotion-aware filtering and ranking of candidate facilities or routes. The candidate selection module may compute a composite score for each candidate based on a multi-term objective function. For instance, server may compute a score S for each candidate facility as:

S=w1×fdistance+w2×frating+w3×fcongestion+w4×femotion_match, where fdistance is a function describing normalized distance from the user, frating is a function of the facility rating, fcongestion is an inverse of a congestion level, and femotion_match is a function indicating category suitability given the user's emotion. The weights w1, w2, w3, and w4 may be predetermined or adaptively tuned. Server may, for a “tired” emotion state, increase w4 to give more weight to relaxation-related categories and reduce w3 to tolerate slightly higher congestion at locations that strongly match relaxation-related categories. Server then sorts candidates by S and selects the top N candidates as selection results.

Server then uses the response generation and delivery module to generate natural language response information based on the selection results. Server may produce another prompt sentence containing structured data representing the selected candidates and instructions to the generative AI model for formatting. For example, server may generate:

“You are an AI chatbot that provides city information. The user is tired. Here are 3 candidate relaxing places near the user with fields (name, type, distance, rating, congestion_level).

Recommend 2-3 places in Japanese, politely, and explain briefly why each is suitable for relaxation.”

Server provides this prompt sentence and the candidate data to the generative AI model and receives a natural language response such as:

“There is a quiet cafe a 5 minute walk from the current location. The restaurant is relatively empty and has a relaxed atmosphere. There is also a reputable massage parlor B, a 10-minute walk away. It is recommended if you want to take a rest.”

Server finally transmits the response information and the selection results to the user terminal. Terminal displays the response on the display unit and, in some embodiments, uses a text-to-speech engine to convert the response text into audio output. When the user terminal is mounted on a moving body, such as a vehicle, terminal may forward the route information included in the selection results to a route guidance unit. The route guidance unit then computes control outputs for actuators or generates turn-by-turn guidance instructions. This integration allows the system to directly affect the control and behavior of the moving body in the physical world.

In another embodiment, server generates prompt sentences that already embed structured data representing urban information retrieved at an earlier stage. For example, server may construct a prompt sentence such as:

“Based on the following facility data (name, category, rating, distance, congestion_level), select the best two options for a stressed user and generate a Japanese explanation: [facility list here]. The user emotion is STRESSED and the intent is GET_RELAXING_PLACE.”

In this embodiment, the generative AI model is used not to determine what data to retrieve, but to convert precisely defined candidate data into an explanation layer that is more comprehensible to the user, while the numerical selection logic remains in the candidate selection module. This separation allows server to efficiently manage data retrieval and scoring, while delegating language generation to the generative AI model.

Server improves computer technology in several ways. First, by converting natural language inquiries, user emotions, and external data into unified prompt sentences for a generative AI model, server reduces the complexity of hard-coded conversational rules and can handle a larger variety of input expressions and data sources without duplicating logic. The use of structured prompt sentences also reduces unnecessary external data acquisition, because server directs external devices in a targeted way according to intent and emotion rather than sending broad or indiscriminate queries. This selective acquisition leads to reduced network bandwidth consumption and lower processing overhead.

Second, by performing emotion-aware scoring and filtering using formal, quantitative functions on structured data, server reduces the volume of candidate information that needs to be handled by the generative AI model and the user terminal. Instead of transmitting and rendering full result sets from multiple data sources, server narrows the set of candidates to a small, high-relevance subset, which reduces rendering load on the terminal and improves user-perceived responsiveness.

Third, by structuring the system so that the generative AI model is invoked with explicit prompt sentences that include both instructional text and structured data, server enables deterministic control over the generative model's behavior. The model does not act as a black box; instead, server constrains it by specifying the context, the type of output, and in some embodiments, the evaluation criteria to be used. This reduces errors such as ungrounded or irrelevant answers and improves overall system accuracy.

Fourth, by integrating the selection result with a route guidance unit in a moving body, server enables automatic route control or guided navigation that adapts to real-time urban information and user emotion. This integration is not merely an automation of human route planning; rather, server continuously receives sensor and urban data, recomputes candidate routes using numeric algorithms, and updates the moving body's control parameters more quickly and consistently than would be feasible with manual operation.

Server trains the neural network models used in the natural language processing module, the emotion analysis module, and the generative AI module using machine learning methods. For the classification models (intent and emotion), server defines loss functions such as categorical cross-entropy and updates parameters via gradient-based optimization. Server may use regularization techniques such as dropout, weight decay, and early stopping to prevent overfitting. For the generative AI model, server may pre-train the model on large text corpora and fine-tune it on domain-specific data including urban and route guidance scenarios. The training data may also include pairs of prompt sentences and desired model outputs, so that the model learns to follow the specific instruction style used by server.

In some embodiments, server uses feature engineering to enhance input signals to the models. For example, server may provide additional features such as normalized time-of-day, day-of-week, or simple statistics of historical user behavior to the classifier networks. These features help the models disambiguate similar linguistic expressions with different contextual meanings.

Terminal can be implemented in multiple variations. When the terminal is a handheld device, the device may run a mobile operating system and a native or cross-platform application that communicates with server via an application programming interface. When the terminal is a vehicle-mounted device, the device may be integrated with a vehicle network and may receive route information in a format compatible with the existing navigation system. Terminal may also include a local cache for frequently accessed map tiles or facility descriptors, which further reduces repeated data transfer from server.

Server may adopt alternative configurations for the generative AI model. For instance, server may use a smaller model deployed at the network edge for latency-sensitive scenarios, and a larger model deployed in a centralized data center for more complex, non-real-time reasoning. Server can select an appropriate model based on current load and quality-of-service requirements. In some embodiments, server may combine outputs of multiple generative models using a ranking or voting algorithm.

Server may optionally log user interactions, selected candidates, and performance metrics such as latency and error rates. Server can use these logs to retrain or adapt scoring functions. For example, if users consistently ignore certain types of recommended places under specific emotion states, server may decrease the corresponding weights in the scoring formula. This adaptation is performed by algorithmic updates to parameters on the server side rather than by manual rewriting of rules.

By implementing the system as described above, server, terminal, and user cooperate in a way that goes beyond simple automation of human decision-making. Server uses specific data structures, tailored neural architectures, and mathematically defined scoring algorithms to transform unstructured natural language inquiries and noisy, heterogeneous urban data into actionable information and control signals. This configuration improves processing efficiency, accuracy of intent and emotion recognition, relevance of retrieved information, and responsiveness of route guidance, thereby providing a concrete technical improvement in computer-based information processing and control.

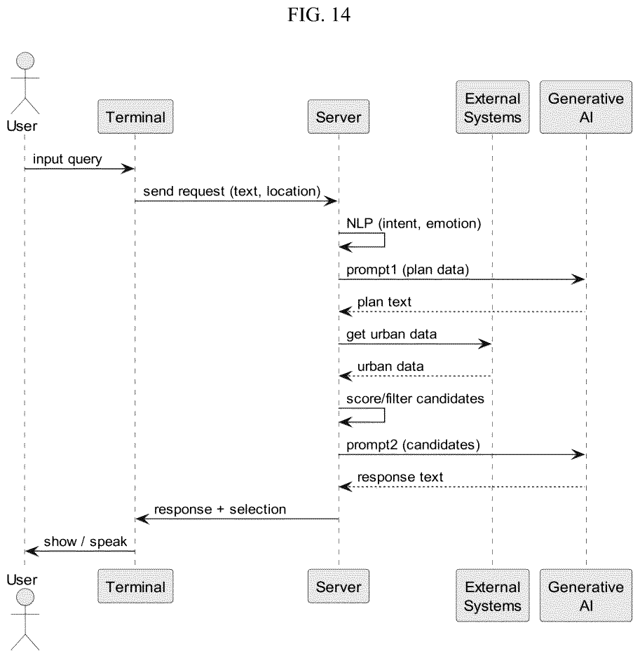

The following describes the processing flow using FIG. 14.

### Step 1:

User inputs a natural language inquiry.

User operates the terminal and provides an inquiry via a messaging interface. User types a text message such as “Tell me the current traffic situation” or “Let me know the nearest restaurant.”, or speaks a voice command such as “I'm tired today.”.
Input: Raw user text or speech.
Output: User message captured by the terminal's input unit (text buffer or audio buffer).

### Step 2:

Terminal converts the user input into a structured request.

Terminal, when receiving speech, applies a speech recognition engine to convert audio into text. Terminal acquires current location information from a positioning unit and associates a user identifier or session identifier with the text. Terminal constructs a structured request object that includes at least the user text, current location, timestamp, and terminal type. Terminal sends this request object to the server via a messaging communication unit using a network protocol.
Input: User text or audio, current location, terminal metadata.
Output: Structured request object transmitted to the server.

### Step 3:

Server parses the natural language inquiry and extracts intent information.

Server receives the structured request and stores it in a request log. Server passes the user text to a natural language processing module. Server tokenizes the text, normalizes tokens, and embeds the token sequence using a transformer-based encoder. Server feeds the embedding into an intent classification layer that outputs an intent label such as GET_TRAFFIC_INFO, GET_NEARBY_FACILITY, or GET_RELAXING_PLACE.
Input: Structured request object containing user text and metadata.
Output: Intent information (intent label and confidence score) attached to the request context.

### Step 4:

Server derives emotion information from the user text.

Server applies an emotion analysis model to the same tokenized text. Server computes an embedding and feeds it into an emotion classifier that outputs a probability distribution over emotion categories such as NEUTRAL, TIRED, STRESSED, or POSITIVE. Server selects the category with highest probability as the emotion label and stores both the label and probability vector.
Input: User text and tokenized representation.
Output: Emotion information (emotion label and probability values) stored in the request context.

### Step 5:

Server composes a first prompt sentence for the generative AI model.

Server aggregates the intent information, the emotion information, the current location information, and any relevant session context. Server constructs a textual prompt sentence by inserting these values into a predefined template. For example, server may generate: “The user says: ‘Let me know the current traffic situation.’. Intent: GET_TRAFFIC_INFO. Emotion: NEUTRAL. Current location: [35.6812, 139.7671]. As an urban assistant, decide which traffic information to obtain from external devices and how to summarize current congestion and an optimal route in polite Japanese.”
Input: Intent information, emotion information, current location, session context.
Output: First prompt sentence supplied to the generative AI model.

### Step 6:

Server uses the generative AI model to obtain an external data acquisition plan.

Server sends the first prompt sentence to a generative AI model interface. Server receives generated text that describes a proposed acquisition plan, such as a list of data types to request, spatial and temporal constraints, and threshold values. Server parses this generated text to extract machine-usable parameters, such as a search radius, facility categories, or congestion thresholds.
Input: First prompt sentence.
Output: External data acquisition plan including parameters for subsequent API calls.

### Step 7:

Server requests urban information from external information providing devices.

Server, based on the acquisition plan, calls one or more external devices, such as a geographic information system, a route computation service, a congestion information service, or an urban information database. Server sends queries that include coordinates, radius, categories, and time constraints. External devices return structured records describing facilities, routes, traffic conditions, congestion levels, and safety indicators. Server aggregates and normalizes these records into a unified internal data structure.
Input: External data acquisition plan and stored current location.
Output: Urban information dataset in a structured format stored in server memory.

### Step 8:

Server computes candidate facilities and candidate routes.

Server analyzes the urban information dataset to identify items relevant to the detected intent. For a facility search intent, server extracts all facility records that match required categories. For a route intent, server extracts all route options meeting basic feasibility criteria. Server organizes these items into candidate lists and attaches derived attributes, such as estimated travel time from current location, distance, and normalized congestion scores.
Input: Urban information dataset and intent information.
Output: Candidate facilities list and/or candidate routes list, each with associated attributes.

### Step 9:

Server applies emotion-aware scoring and filtering to candidates.

Server defines a numeric scoring function that combines distance, rating, congestion level, category suitability, and emotion match. Server computes a score for each candidate facility or route by applying this function. Server filters out candidates whose score falls below a threshold and sorts the remaining candidates in descending order of score. Server selects a limited number of top-scoring candidates as selection results.
Input: Candidate facilities and/or routes with attributes, emotion information, and scoring parameters.
Output: Selection result consisting of at least one candidate facility or at least one candidate route.

### Step 10:

Server constructs a second prompt sentence for response generation.

Server serializes the selection result into a structured description, including for each candidate at least a name, type, distance, rating, and congestion level. Server creates a second prompt sentence that includes this structured description, the intent information, and the emotion information, along with instructions on output style. For example, server may generate:
“You are an AI chatbot that provides city information. The user is tired. Here are 3 candidate relaxing places near the user with fields (name, type, distance, rating, congestion_level). Recommend 2-3 places in Japanese, politely, and explain briefly why each is suitable for relaxation.”
Input: Selection result, intent information, emotion information, and candidate attributes.
Output: Second prompt sentence supplied to the generative AI model.

### Step 11:

Server generates natural language response information using the generative AI model.

Server sends the second prompt sentence and the serialized candidate data to the generative AI model. Server receives a generated text output that provides a human-readable explanation and recommendation referencing the candidates. Server may perform post-processing such as length checking, removal of undesired expressions, and insertion of line breaks.
Input: Second prompt sentence and structured candidate data.
Output: Natural language response information ready for delivery to the terminal.

### Step 12:

Server transmits the response information and selection result to the terminal.

Server packages the natural language response and the structured selection result, including any route coordinates or facility coordinates, into a response message. Server sends this message to the terminal via the messaging communication unit. Server may log the transmitted content for future analysis or model tuning.
Input: Natural language response information and selection result.
Output: Response message delivered to the terminal.

Step 13:

Terminal presents the response information to the user.

Terminal receives the response message and extracts the response text and structured data. Terminal displays the response text on the display unit as a message or notification. For facility recommendations, terminal may render map markers at the coordinates of the selected facilities. For route selections, terminal may draw a polyline representing the chosen route. Terminal may also convert the response text to audio using a text-to-speech engine and output the audio via the audio output unit.
Input: Response message containing natural language text and structured selection result.
Output: Visual and/or audio presentation of the response to the user.

### Step 14:

Terminal, when mounted on a moving body, forwards route information to a route guidance unit.

Terminal, upon detecting that the selection result includes route information and that the terminal is integrated with a moving body, transmits the route information to an on-board route guidance unit. The route guidance unit interprets waypoints, turn instructions, and constraints, and generates control commands or spoken navigation instructions. Terminal may display turn-by-turn directions synchronized with the guidance unit.
Input: Route information contained in the selection result.
Output: Route configuration and guidance commands delivered to the route guidance unit.

### Step 15:

User reacts to the presented information and optionally issues a follow-up inquiry.

User reviews the displayed text or listens to the audio output and decides whether to follow the recommended route or visit a recommended facility. User may trigger navigation, select a specific candidate, or provide additional constraints in a follow-up inquiry such as “Show me a cheaper option” or “Avoid highways.” User's new input is then captured by the terminal and re-enters the processing flow from Step 1.
Input: Presented response information and user's subjective decision.
Output: User action (navigation start, selection of a candidate, or new inquiry) leading to subsequent processing.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

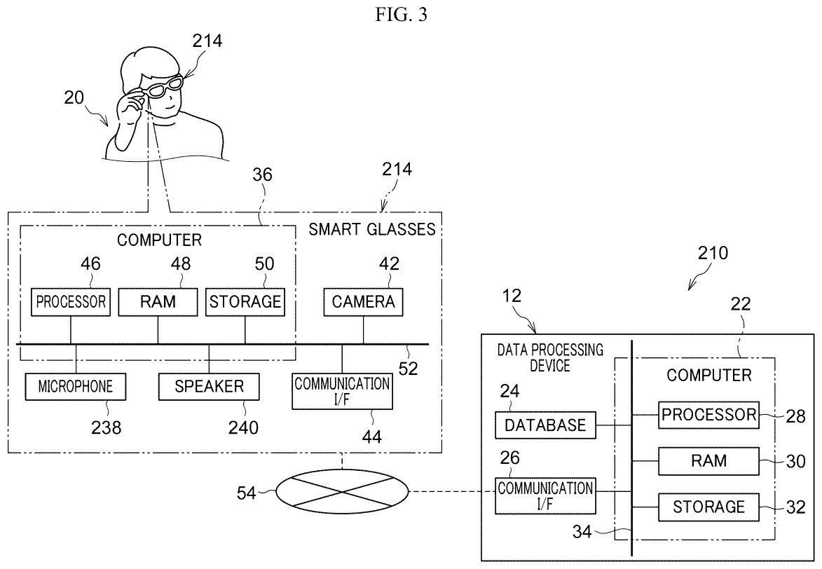

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

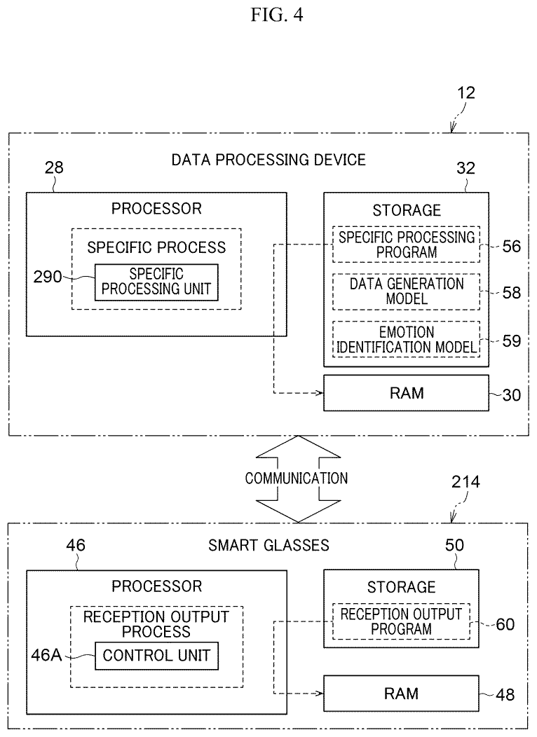

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

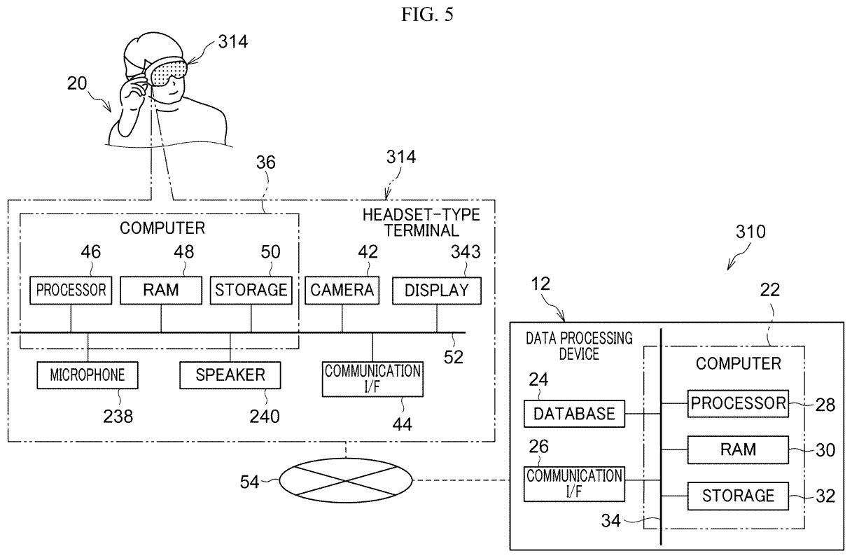

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

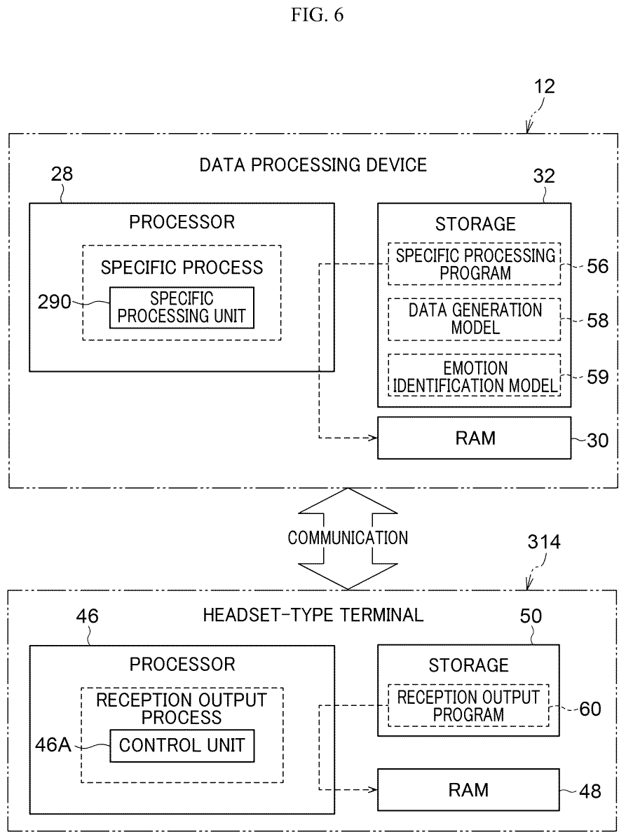

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

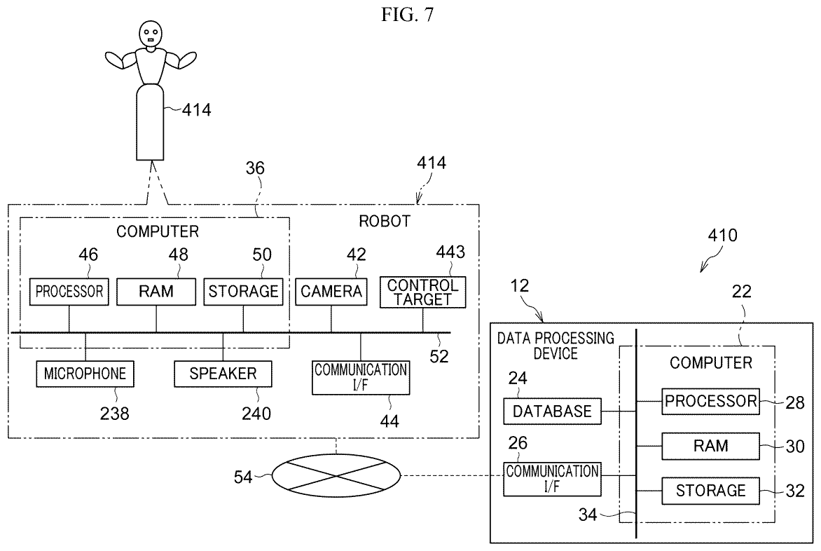

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

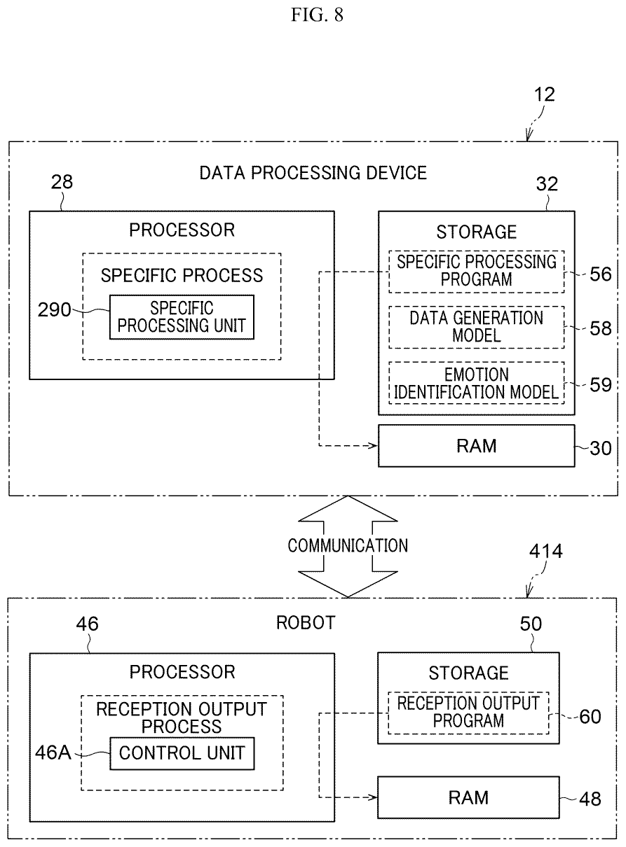

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

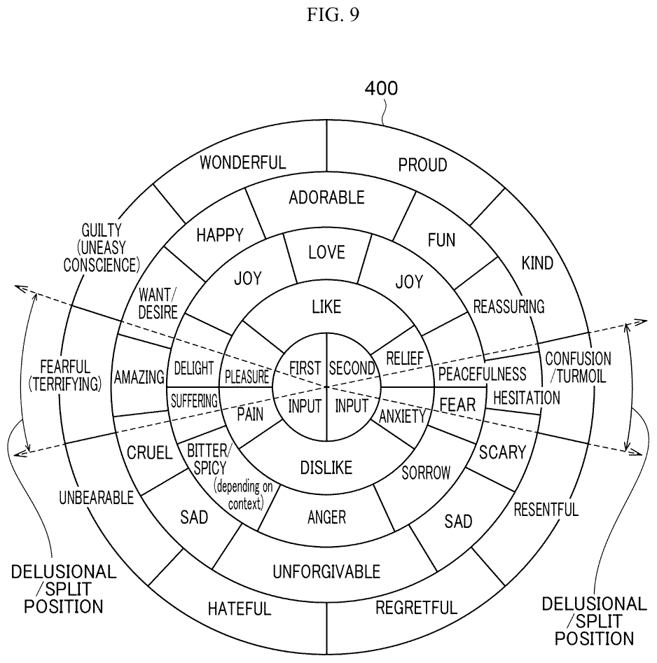

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

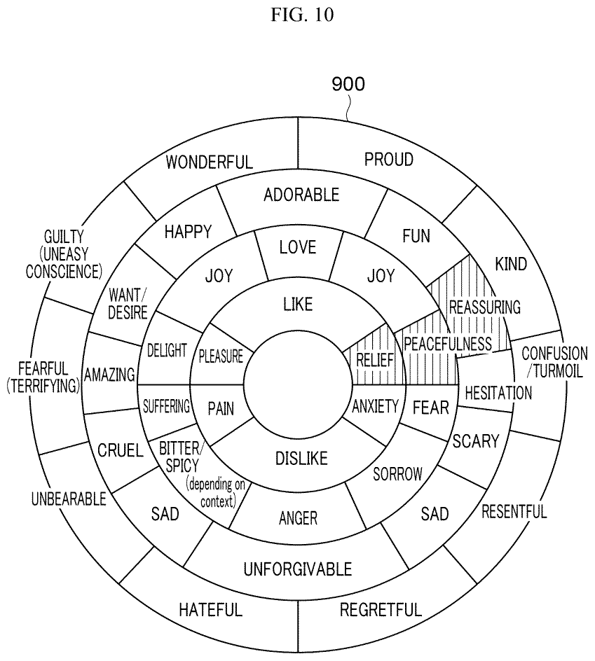

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive inquiry information obtained from a user terminal via a communication application, and convert the inquiry information into structured information including intent information and target area information by using a natural language processing technique,
determine, based on the structured information, target data sources and acquisition conditions for obtaining data from a plurality of measurement devices and information providing devices related to an urban environment, and generate analysis result data including a result of the determination,
generate a prompt sentence including the analysis result data and the inquiry information, cause a generative AI model to be executed by using the prompt sentence as input, and obtain natural language response information from the generative AI model,
integrate time-series data and state data acquired from the target data sources, calculate index values including at least one of congestion degree and crowding degree based on the analysis result data, and perform data processing and data computation for reflecting the index values in the natural language response information,
execute an emotion analysis process for estimating a psychological state of a user based on the inquiry information and the integrated data, and generate response information useful for a next action of the user by selecting or modifying the natural language response information obtained from the generative AI model in accordance with the psychological state, and transmit the response information to the user terminal via the communication application.

### (Supplementary 2)

The system according to supplementary 1,
wherein the processor is configured to
use, as the target data sources, a plurality of detection devices installed in infrastructure of a city and information processing devices that provide operation information related to the infrastructure of the city, and generate the prompt sentence so as to include an instruction to obtain real-time data from the detection devices and the information processing devices and to perform response generation using the real-time data in the generative AI model.

### (Supplementary 3)

The system according to supplementary 1,
wherein the processor is configured to
classify the psychological state of the user in the emotion analysis process based on context information included in the inquiry information and the integrated data, and, when the psychological state is determined to be a stress state or an anxiety state, add instruction information to the prompt sentence to include candidate information on at least one of a quiet place and an entertainment facility, and cause the generative AI model to generate response information including the candidate information.

### Application Example 1

### (Supplementary 1)

A system comprising a processor,
wherein the processor is configured to
receive, via a messaging application executed on a terminal device, an inquiry sentence in natural language from a user and analyze the inquiry sentence, and
preprocess, based on the analysis of the inquiry sentence, time-series data and image data acquired from detection devices and imaging devices arranged in an urban space, by using a general-purpose program execution environment to perform noise removal, missing-data compensation, and feature extraction related to movement of people and vehicles, and
estimate, for the preprocessed data, congestion levels, moving-object densities, and traffic-flow indicators as numerical values by using analysis software including a machine-learning library, and
generate, on the basis of the estimated results and associated position information and time information, visual information indicating spatial distributions, by using an image-processing library to create color-coded representations of the congestion levels and traffic conditions, and
generate, on the basis of the estimated results and the visual information, a prompt sentence to be input to a generative AI model, and cause the generative AI model to generate a natural-language response sentence corresponding to the user's inquiry, and
transmit, via the messaging application, the generated response sentence and the visual information to the terminal device, and provide the transmitted response sentence and visual information in real time as information that supports a visit plan or a movement plan of the user.

### (Supplementary 2)

The system according to supplementary 1,
wherein the processor is configured to
use urban information acquired from an urban infrastructure constituting a smart city as a target of the preprocessing and the estimation, and update contents of the prompt sentence to be input to the generative AI model in accordance with a real-time property of the urban information.

### (Supplementary 3)

The system according to supplementary 1,
wherein the processor is configured to
estimate an emotional state of the user by using emotion-analysis software on the basis of the inquiry sentence received from the terminal device and the estimated results, and, on the basis of the emotional state, the congestion levels, and the traffic conditions, preferentially select an area having high quietness, an area having short dwell time, or an evacuation-related area having high safety, and generate the prompt sentence to the generative AI model so as to provide information regarding the selected area.

### Example 2

### (Supplementary 1)

A system comprising a processor,
wherein the processor is configured to
acquire, as analysis target text, an inquiry message in natural language received from a user terminal via a message communication process executed by an information processing apparatus, and
input the analysis target text to a natural language processing engine and obtain an analysis result including information relating to a user intention and information relating to a location, and
execute a query process to acquire traffic-state information from at least one of an information storage apparatus that stores state information relating to a moving body and an external information providing apparatus, based on the analysis result, and
determine, based on the analysis result, whether it is necessary to acquire disaster-prevention-related information from an external information providing apparatus that provides information relating to an environmental abnormality, and, when it is determined that the acquisition is necessary, acquire the disaster-prevention-related information from the external information providing apparatus, and
generate a prompt sentence including structured data obtained by integrating the traffic-state information and the disaster-prevention-related information and including the inquiry message, and input the prompt sentence to a generative AI model, and
analyze a response text in natural language obtained from the generative AI model, confirm that the response text includes information relating to safety assurance based on the disaster-prevention-related information with higher priority than information relating to the traffic-state information, and, when necessary, modify the response text, and
transmit the modified or confirmed response text to the user terminal via the message communication process and cause the user terminal to display the response text.

### (Supplementary 2)

The system according to supplementary 1,
wherein the processor is configured to
generate query conditions for acquiring real-time traffic-state information from an information storage apparatus that stores state information relating to an urban space, based on the user intention and the information relating to the location included in the analysis result, and execute, as the query process to acquire the traffic-state information, a process of transmitting the query conditions to the information storage apparatus.

### (Supplementary 3)

The system according to supplementary 1,
wherein the processor is configured to
generate the prompt sentence for the generative AI model so as to include a control condition that instructs the generative AI model to provide, in a normal state, an explanation mainly based on the traffic-state information, and, in a state in which an environmental abnormality occurs, to preferentially present advice relating to evacuation action or route change based on the disaster-prevention-related information.

### Application Example 2

### (Supplementary 1)

A system comprising a processor,
wherein the processor is configured to
receive, via a messaging communication unit, a natural language inquiry from a user terminal, and analyze the natural language inquiry using a natural language processing technique to extract intent information indicating a user request and current location information of the user,
generate a prompt sentence for input to a generative AI model based on an analysis result including the intent information and emotion information indicating an emotional state of the user, and, in accordance with the prompt sentence, instruct one or more external information providing devices including at least one of a geographic information providing device, a route guidance device, an environment information acquisition device, and an urban information management device to provide urban information including at least one of traffic condition information, facility information, congestion information, and safety-related information, filter the urban information using the generative AI model based on the emotion information and the intent information, select at least one candidate facility or at least one candidate route from among a plurality of candidate facilities or a plurality of candidate routes in accordance with the emotional state and the user request, and generate response information in natural language based on a further prompt sentence supplied to the generative AI model, and transmit the response information and selection result to the user terminal so that the user terminal presents the response information and the selection result to the user via at least one of a display unit and an audio output unit.

### (Supplementary 2)

The system according to supplementary 1,
wherein the processor is configured to generate the prompt sentence as text information including the intent information, the emotion information, the current location information, and structured data representing the urban information, and to cause the generative AI model to evaluate the plurality of candidate facilities or the plurality of candidate routes based on the structured data and generate a recommendation that preferentially selects a candidate corresponding to the emotional state of the user.

### (Supplementary 3)

The system according to supplementary 1,
wherein the processor is configured to, in a case where the user terminal is mounted on a moving body, generate route information including a travel route of the moving body as the selection result, and provide the route information to a route guidance unit of the moving body so as to cause automatic travel control or route guidance control of the moving body based on the route information.

What is claimed is:

1. A system comprising:
circuitry configured to:
receive, via a communication interface coupled to a packet-switched network, inquiry information from a terminal device via a communication application, and convert the inquiry information into structured information comprising intent information and target area information using a natural language processing model;
determine, based on the structured information, target data sources and acquisition conditions for obtaining data from a plurality of measurement devices and information providing devices, and generate analysis result data comprising a result of the determination;
acquire time-series data and state data from the target data sources, integrate the time-series data and the state data, and calculate index values comprising at least one of a congestion degree value and a crowding degree value based on the integrated data;
generate a prompt sentence comprising the analysis result data, the index values, and the inquiry information, execute inference processing using a generative neural network model with the prompt sentence as input to obtain natural language response information; and
execute an affective state estimation process based on at least the inquiry information and the integrated data to estimate a psychological state of the user, select or modify the natural language response information in accordance with the estimated psychological state to generate response information, and transmit the response information to the terminal device via the communication interface.

2. The system according to claim 1, wherein the circuitry is configured to extract the intent information from the inquiry information by applying named entity recognition and intent classification processing to identify at least one of a query topic, a requested action type, and a target area identifier.

3. The system according to claim 2, wherein the circuitry is configured to determine the target data sources by mapping the intent information and the target area information to a data source registry associating area identifiers with measurement devices and information providing devices.

4. The system according to claim 3, wherein the circuitry is configured to generate the acquisition conditions by constructing query parameters specifying at least one of a time range, a spatial region, and a data type filter for each target data source.

5. The system according to claim 4, wherein the circuitry is configured to integrate the time-series data and the state data by synchronizing records from each target data source on a common time axis and applying at least one of interpolation and aggregation processing to generate a unified data set.

6. The system according to claim 5, wherein the circuitry is configured to calculate the congestion degree value and the crowding degree value from the integrated data by applying a density estimation function to pedestrian count data and vehicle count data within the target area.

7. The system according to claim 1, wherein the circuitry is configured to construct the prompt sentence by embedding the analysis result data, the index values, the intent information, and the inquiry information into a natural language template as structured constraint fields.

8. The system according to claim 7, wherein the circuitry is configured to include the estimated psychological state in the prompt sentence as a style condition to cause the generative neural network model to adapt the tone and content emphasis of the natural language response information.

9. The system according to claim 1, wherein the circuitry is configured to execute the affective state estimation process by applying a sentiment analysis model to the inquiry information, and combining the sentiment analysis result with behavioral signals derived from the integrated data.

10. The system according to claim 9, wherein the circuitry is configured to select the response information by filtering candidate natural language response information to exclude content predicted to increase stress, when the estimated psychological state indicates an elevated stress level.

11. The system according to claim 9, wherein the circuitry is configured to modify the natural language response information to add action recommendation data when the estimated psychological state indicates a need for behavioral support.

12. The system according to claim 1, wherein the circuitry is configured to store the inquiry information, the structured information, the prompt sentence, and the response information as interaction log data in a storage device, and update acquisition condition parameters based on accumulated interaction log data.

13. The system according to claim 12, wherein the circuitry is configured to retrieve, from the stored interaction log data, prior response information associated with similar intent information and target area information using a similarity search, and incorporate the retrieved information as context data in a subsequent prompt sentence.

14. The system according to claim 1, wherein the circuitry is configured to receive the inquiry information via at least one of a text messaging interface and a voice interface of the communication application.

15. The system according to claim 14, wherein the circuitry is configured to convert voice input from the voice interface to text data using a speech recognition model, and process the converted text data as the inquiry information.

16. The system according to claim 1, wherein the circuitry is configured to update index value calculation parameters based on newly acquired time-series data, and dynamically adjust data source selection conditions in response to changes in the integrated data.

17. The system according to claim 16, wherein the circuitry is configured to detect anomalous patterns in the time-series data by comparing computed index values against threshold values, and include detected anomaly information in the prompt sentence.

18. A system comprising:
circuitry configured to:
receive, via a communication interface coupled to a packet-switched network, inquiry information from a terminal device via a communication application, apply a natural language processing model to extract intent information and target area information from the inquiry information, and determine target data sources and acquisition conditions based on the intent information and the target area information;
acquire time-series data and state data from the target data sources, integrate the acquired data, and calculate at least one of a congestion degree value and a crowding degree value from the integrated data;
generate a prompt sentence embedding the intent information, the acquisition result data, and the calculated index values, and execute inference processing using a generative neural network model with the prompt sentence as input to generate natural language response information; and
apply a sentiment analysis model to the inquiry information to estimate a psychological state of the user, select or modify the natural language response information based on the estimated psychological state to generate response information, and transmit the response information to the terminal device via the communication interface.

19. The system according to claim 18, wherein the circuitry is configured to detect anomalous patterns in the time-series data by comparing computed index values against threshold values, and include detected anomaly information in the prompt sentence as an additional constraint.

20. A method comprising:
receiving, via a communication interface coupled to a packet-switched network, inquiry information from a terminal device via a communication application, and converting the inquiry information into structured information comprising intent information and target area information using a natural language processing model;
determining, based on the structured information, target data sources and acquisition conditions for obtaining data from a plurality of measurement devices and information providing devices, and generating analysis result data comprising a result of the determination;
acquiring time-series data and state data from the target data sources, integrating the time-series data and the state data, and calculating index values comprising at least one of a congestion degree value and a crowding degree value based on the integrated data;
generating a prompt sentence comprising the analysis result data, the index values, and the inquiry information, executing inference processing using a generative neural network model with the prompt sentence as input to obtain natural language response information; and
executing an affective state estimation process based on at least the inquiry information and the integrated data to estimate a psychological state of the user, selecting or modifying the natural language response information in accordance with the estimated psychological state to generate response information, and transmitting the response information to the terminal device via the communication interface.
